(19) United States
(12) Patent Application Publication
(10) Pub. No.: US 2026/0349978 A1
(43) Pub. Date: Nov. 5, 2026

(54) METHOD AND SYSTEM FOR AUTOMATED DATA CURATION AND QUALITY ASSESSMENT OF LARGE LANGUAGE MODEL TRAINING DATASETS USING STATISTICAL OUTLIER DETECTION

(71) Applicants: Bharath R Rao, Noida (IN); Swapnil Kumar, Bengaluru (IN); Konda Avinash, nellore (IN)

(72) Inventors: Bharath R Rao, Noida (IN); Swapnil Kumar, Bengaluru (IN); Konda Avinash, nellore (IN)

(21) Appl. No.: 19/196,002

(22) Filed: May 1, 2025

(51) Int. Cl. G06F 16/215; G06F 16/22; G06F 16/28

(52) U.S. Cl. CPC G06F 16/215; G06F 16/2246; G06F 16/285

(57) ABSTRACT

In one aspect, a computer-implemented method for automated data curation with reduced human annotation, the method comprising the following steps. The processor captures a user's perception of underlying topics, labels, and classes in a hierarchical data structure. The processor then auto-classifies a plurality of text paragraphs to corresponding classes using similarity scoring. Next, the processor generates a diverse set of prompts to ensure comprehensive data coverage using divisive sampling techniques. The processor produces quality responses that align with user requirements using an information retrieval system integrated with large language models. The method continues as the processor identifies specific data points requiring user validation through quality evaluation metrics. The processor improves auto-annotation of new data based on user feedback by implementing ensemble active learning approaches. Finally, the processor generalizes user validation performed on a representative sample to a wider set of text for task-specific data curation, significantly reducing the overall human annotation effort required.

### BACKGROUND

In recent years, modern machine learning models have achieved unprecedented state-of-the-art (SOTA) accuracies across a wide range of traditionally challenging problems. During this same period, Large Language Models (LLMs) have experienced widespread adoption across various industries, fundamentally transforming tasks and enabling new forms of innovation. Organizations are increasingly pursuing the development of sophisticated AI systems, including automated Q & A systems, retrieval-augmented generation (RAG) solutions, chatbots, and generative AI services. These applications frequently require customized or fine-tuned large language models to effectively address domain-specific challenges.

To meet these specialized requirements, new techniques have emerged, such as Parameter-Efficient Fine-Tuning (PEFT) and Direct Preference Optimization (DPO), which enable more effective alignment of LLMs with specific business requirements. The performance of these models, however, is heavily dependent on both the reliability and quantity of labeled training and testing datasets.

With recent advancements in the automation and commoditization of many machine learning models, including LLM frameworks like RAG and fine-tuning techniques such as PEFT and DPO, researchers and organizations have increasingly focused their efforts on creating and acquiring high-quality labeled datasets for various business purposes. This shift, however, has introduced significant challenges. The cost of data labeling has emerged as a substantial operational expense for organizations. Furthermore, the labeling process itself can introduce multiple forms of bias, including Sample Bias, Exclusion Bias, Measurement Bias, Recall Bias, Observer Bias, and Racial Bias.

While some of these biases are inherently present in use cases and reflect underlying data skewness, certain biases—particularly Recall Bias, Observer Bias, and Racial Bias—are unintentionally introduced during the manual annotation and labeling process. This issue is particularly pronounced in Generative AI use cases, which require the curation of datasets containing prompt-response pairs, potentially leading to bias induction at both the prompt and response stages.

Although LLMs can be employed with prompt engineering to partially automate the curation of prompt and response pairs, this approach faces several significant limitations. First, the generated datasets often fail to scale effectively for large, diverse requirements. Second, the resulting prompts and responses frequently do not adequately represent the dataset's diversity or class distribution. Third, the generated content often lacks proper alignment with domain-specific nuances, leading to reduced accuracy. Fourth, automated methods tend to produce redundant prompts and responses, which diminishes overall dataset quality. Finally, these techniques demonstrate limited adaptability when confronted with complex, dynamic data structures and evolving requirements.

These challenges highlight the critical need for more advanced, scalable, and automated data annotation and curation techniques that can reduce human effort while maintaining or improving the quality of the resulting datasets. Such innovation would significantly reduce costs, accelerate the machine learning development cycle, and enable more organizations to successfully deploy AI systems customized for their specific domains and requirements.

### SUMMARY OF THE INVENTION

In one aspect, a computer-implemented method for automated data curation with reduced human annotation, the method comprising the following steps. The processor captures a user's perception of underlying topics, labels, and classes in a hierarchical data structure. The processor then auto-classifies a plurality of text paragraphs to corresponding classes using similarity scoring. Next, the processor generates a diverse set of prompts to ensure comprehensive data coverage using divisive sampling techniques. The processor produces quality responses that align with user requirements using an information retrieval system integrated with large language models. The method continues as the processor identifies specific data points requiring user validation through quality evaluation metrics. The processor improves auto-annotation of new data based on user feedback by implementing ensemble active learning approaches. Finally, the processor generalizes user validation performed on a representative sample to a wider set of text for task-specific data curation, significantly reducing the overall human annotation effort required.

In another aspect, a computer-implemented method for automated data curation comprises several integrated steps that work together to significantly reduce manual annotation requirements. The method begins by generating a divisive sampling through clustering a plurality of input data points into multiple clusters, specifically prioritizing boundary-critical data points that exist near decision boundaries for maximum learning efficiency. The process then applies ensemble active learning techniques to this divisive sampling, which allows the system to iteratively refine the dataset through structured feedback cycles that continuously improve model performance. Next, the method automatically annotates a strategic subset of data points by leveraging a masterlist containing hierarchical node relationships that capture taxonomic connections between classes and their associated keywords. Finally, the method achieves substantial reduction in human annotation effort by performing systematic quality evaluation and implementing strategic validation processes for the annotated data points, ensuring high accuracy while minimizing manual intervention.

### BRIEF DESCRIPTION OF THE DRAWINGS

FIG. 1 illustrates an example process for implementing an automated and scalable system for annotating and curating high-quality domain-specific datasets for ML model training and LLM fine-tuning with minimal human supervision, according to some embodiments.

FIG. 2A illustrates an example process for Divisive Sampling for classical NLP use cases, according to some embodiments.

FIG. 2B illustrates an example process for Divise Sampling And Ensemble Active Learning (DSEAL), according to some embodiments.

FIG. 3 illustrates an example process for implementing a DataNeuron, according to some embodiments.

FIG. 4 illustrates an example process for a DataNeuron workflow, according to some embodiments.

FIG. 5 illustrates an example Master List, according to some embodiments.

FIG. 6 illustrates an example Visual Concept of Strategic Sampling in Stage 1 and Stage 2, according to some embodiments.

FIG. 7 illustrates an example process for an annotation flow, according to some embodiments.

FIG. 8 illustrates an example process for implementing stage 1, according to some embodiments.

FIG. 9 illustrates an example process for implementing Stage 2, according to some embodiments.

FIG. 10 illustrates an example process for generalization of a model from Stage 2, according to some embodiment.

FIG. 11 illustrates an example screenshot Semi-Supervised & Supervised Annotation and Strategic Sampling in a single batch of Stage 2, according to some embodiments.

FIG. 12 illustrates an example process for implementing Stage 3, according to some embodiments.

FIG. 13 illustrates an example output table showing an example result after final model is trained, according to some embodiments.

FIG. 14 illustrates an example process for implementing a DataNeuron system's processing workflow, according to some embodiments.

FIG. 15 illustrates an example process for implementing a DataNeuron's workflow, according to some embodiments.

FIG. 16 illustrates an example process for DSEAL prompt generation workflow, according to some embodiments.

FIG. 17 illustrates an example algorithm for using techniques like K-Means clustering to organize the embedded chunks into semantically similar groups, according to some embodiments.

FIG. 18 illustrates an example algorithm for using divisive sampling to select a diverse subset of chunks from across different clusters, according to some embodiments.

FIG. 19 illustrates an example algorithm for prompt filtering based on their quality scores, according to some embodiments.

FIG. 20 illustrates an example algorithm for sampling and final selection of prompts for users' validation within a batch, according to some embodiments.

FIG. 21 illustrates an example process for divisive sampling of prompts, according to some embodiments.

FIG. 22 illustrates an example process for ensemble active learning, according to some embodiments.

FIG. 23 illustrates an example process for DSEAL response generation, according to some embodiments.

FIG. 24 illustrates an example process for divisive sampling for response generation, according to some embodiments.

FIG. 25 illustrates an example algorithm for K-Means clustering of questions/prompts, according to some embodiments.

FIG. 26 illustrates an example algorithm for divisive sampling of prompts for response generation, according to some embodiments.

FIG. 27 illustrates an algorithm for response generation and evaluation of their quality scores, according to some embodiments.

FIG. 28 illustrates an example algorithm for Response filtering based on their quality scores, according to some embodiments.

FIG. 29 illustrates an example algorithm for Response sampling for users' validation, according to some embodiments.

FIG. 30 illustrates an example process for an ensemble active learning workflow, according to some embodiments.

The Figures described above are a representative set and are not an exhaustive with respect to embodying the invention.

### DESCRIPTION

Disclosed are a system, method, and article of manufacture for automated data curation and quality assessment of large language model training datasets using statistical outlier detection. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Active Learning: Technique in which data is strategically sampled for user validation in iterations to achieve maximum accuracy in minimum possible data points. It is an iterative machine learning approach that intelligently selects the most informative data points for human labeling or validation. By focusing on data points near decision boundaries or areas of high uncertainty, Active Learning strategically reduces the total amount of labeled data needed to achieve high model performance. This process continuously improves model accuracy by incorporating human feedback on carefully chosen examples, with each iteration targeting data points that will provide the maximum learning benefit when labeled.

Advanced MasterList: Advanced MasterList features help in defining and improving the classes and their keywords.

Automated Annotation: DataNeuron's stage 1 and stage 2 algorithms annotated data automatically using masterlist information and limited user validated data points.

AutoML: DataNeuron stage 3 feature that automates pre-processing, model creation, hyperparameter optimization, k-fold validation of the accuracy and confidence level.

Batch: A batch represents a set of prompts (and corresponding activities) which are generated together and validated from the user before a next set of prompts can be generated. One batch includes these steps: 1) Prompts are generated based on prompt instruction using LLM and DSEAL; 2) Evaluate the quality of the prompts and categorize them into intervals based on their quality scores; 3) Display prompts to the user for validation. Users can provide feedback for each prompt; 4) Users can give overall feedback for the batch to guide prompt generation in the next batch.

Boundary Examples: Critical cases in machine learning that represent where the model's predictions are most uncertain, lying at the edges of decision boundaries. These examples are often the most challenging for the model to classify correctly, as they occur at the points where the model transitions between different classes or clusters. Annotating these boundary examples is essential for helping the model better understand the complex regions where classes or clusters meet, which leads to more accurate and well-defined decision boundaries.

Boundary-Support Vectors (BSV): Data points that lie directly on the margin boundaries of a support vector machine's decision surface. BSVs play a crucial role in defining the optimal hyperplane that separates different classes in the feature space, as they are the only points that contribute to the determination of the decision boundary. BSVs have non-zero Lagrange multipliers and satisfy the constraint that their functional margin equals one, meaning they are exactly one unit away from the separating hyperplane in the transformed feature space.

Divisive Sampling: A strategic data sampling approach that combines principles from Support Vector Machines (SVMs) and active learning. This technique strategically selects data points by targeting both boundary areas and core regions of data clusters. Divisive Sampling avoids treating all data points equally, instead prioritizing boundary-critical examples near decision boundaries that have the greatest influence on model performance. Unlike traditional SVMs that require fully labeled datasets to identify support vectors, Divisive Sampling extends this concept to unlabeled datasets where decision boundaries are not explicitly known. It works by identifying extreme data points (e.g., support vectors and bounded support vectors) to get closer to cluster boundaries while also sampling data points lying well inside clusters to prevent undesired cluster merging.

DSEAL: Divisive Sampling and Ensemble Active Learning. A methodology that combines two key techniques to improve data curation and annotation efficiency. By focusing on uncertain data points often located near decision boundaries, active learning ensures the model's understanding is enhanced where it matters most. DSEAL uses multiple learning approaches together (the “ensemble” part) to continuously improve data selection and model performance. DSEAL methodologies allow organizations to achieve high-quality data annotation with significantly reduced human effort while maintaining model performance comparable to models trained on fully annotated datasets. This approach is particularly valuable for creating high-quality datasets for training machine learning models and fine-tuning Large Language Models (LLMs) for domain-specific applications.

Dynamic MasterList: Ability of MasterList to define infinite nodes/classes with class attributes for infinite level of hierarchical structure. Using this structure the data can be grouped into domains and subdomains.

Ensemble Active Learning: A technique that continuously refines the dataset through iterative feedback cycles. Ensemble learning combines multiple machine learning models to produce better predictive performance than could be obtained from any single model alone. This approach harnesses the collective intelligence of diverse models, allowing their individual strengths to complement each other while mitigating weaknesses through aggregation techniques like voting, averaging, or weighting.

Graphical Analysis: This aids in understanding relationships between features, so that distinct features can be selected for various Nodes.

Instruction: Prompt instructions are guidelines provided to a large language model (LLM) to shape its prompts for a specific task or domain data. Clear and well-defined instructions ensure the model generates outputs that align with user expectations, delivering accurate, relevant, and contextually appropriate prompts.

Iterate: A part of the complete DataNeuron flow where the user can choose to go back and provide more training paragraphs (by validating more paragraphs or uploading seed paragraphs) or alter the project structure to remove some classes and then retrain the model to achieve better results.

Iterative Learning: A cyclical process where a machine learning model progressively refines its understanding through repeated cycles of training and evaluation. Each iteration builds upon knowledge gained from previous rounds, incorporating new data or feedback to improve the model's performance and accuracy. The process typically involves steps of model training, prediction, validation, and refinement, with each cycle potentially adjusting model parameters, incorporating new training data, or modifying learning strategies based on observed results.

Large Language Models (LLMs): Sophisticated artificial intelligence systems that have achieved state-of-the-art performance across traditionally challenging language tasks, transforming applications across industries. These models can be customized through techniques such as Parameter-Efficient Fine-Tuning (PEFT) and Direct Preference Optimization (DPO) to effectively address domain-specific challenges and business requirements. LLMs form the foundation for modern automated Q&A systems, retrieval-augmented generation (RAG) solutions, chatbots, and generative AI services that organizations increasingly seek to develop. Their performance is heavily dependent on the reliability and quantity of labeled training and testing datasets, making data quality and curation critical factors in their successful deployment.

MasterList: A Hierarchical tree-like data structure, wherein each node represents a label and an associated dictionary of keywords.

Model Node: In a large MasterList, users may not be interested in annotating and classifying data across all the nodes. In such cases, users can highlight which nodes should be used for annotation/classification. Such nodes are called Model Nodes. By default, all Leaf Nodes are considered as Model Nodes.

Multiuser Support: Multiple users can be added to a project in order to contribute in the workflow and more specifically for multiple user validation for quality annotation.

Named Entity Recognition (NER): NER resolves the polysemy of words and features and helps users in making better judgement while associating Keywords to the Nodes.

No-Tag Annotation: In many datasets, not all paragraphs/data-points may belong to one of the Model Nodes. In such cases, the users have the option to switch-on the No-Tag Annotation, which specifically identifies such paragraphs/data-points and excludes them from annotation and classification.

Node: The name of the class/label that the user wishes to define. This is the most basic building block of a MasterList.

Node Accuracy: The accuracy of the annotation and classification of each node is calculated and is shown to the users after the training of the final model is completed. It should be noted that accuracy is initially computed only for Model Nodes. Estimation is used to obtain accuracy at Non-Model Nodes.

Non-Model Node: Non-Model Nodes are Nodes which are not used for annotation and classification. By Default, all Non-Leaf Nodes are Non-Model Nodes. However, users may convert a Non-Leaf Node to a Model Node. However, this switches all of its children/descendants to Non-Model Node.

Prompt: A prompt is a piece of text or a set of instructions that is provided to a Large Language Model (LLM) to trigger a specific response or action.

Scope: A MasterList and a Workflow has 1:1 mapping. So, the scope of MasterList is limited to a single Workflow. However, when a particular Workflow is inherited to create a new version, the corresponding MasterList can also be inherited. In such a scenario, a replica of the existing MasterList is created which can be edited and maintained separately.

Simple Sampling: The process of selecting a subset (sample) from a larger population to estimate or infer characteristics about that population. It is a fundamental technique used in statistics, research, and data science to gather insights or make decisions based on limited data, avoiding the need to analyze an entire population. A simple random sample takes a small, random portion of the entire population to represent the entire data set, where each member has an equal probability of being chosen. Simple random samples are determined by assigning sequential values to each item within a population, then randomly selecting those values.

Stage1: First stage of paragraph validation where DataNeuron's inbuilt stage 1 algorithms automatically annotated data using unsupervised methods.

Stage2: Second stage of paragraph validation where DataNeuron's semi-supervised algorithm uses a combination of strategic sampling and active learning technique to automatically annotate paragraphs.

Strategic Validation: A process followed in algorithms to achieve the target with higher accuracy while capturing multiple data points in every attribute with lesser annotation.

Summary and Analysis: The MasterList also gives a summary of all the Nodes defined and identifies if descriptions (Keywords) of certain Nodes are too similar to differentiate between them. It also suggests the remedial actions to be taken to improve the overall quality of MasterList for creating mutually exclusive classes.

Support Vectors (SV): Data points that lie either exactly on or within the margin boundaries of a support vector machine's decision surface. SVs are critical points that are the only training examples that influence the optimal hyperplane and are used to compute the margin, while all other training examples are ignored during model construction. SVs are characterized by non-zero Lagrange multipliers and include both the points that lie exactly on the margin and those that slightly violate the margin.

Tabular Summary: This represents the relative importances of the features/words and also highlights which paragraphs/data-points use these features to understand their association with the Nodes in a better manner.

Taxonomy and Ontology: A MasterList defines the list and relationships of classes/nodes in the top-down hierarchical fashion. It is assumed that relationships defined in the MasterList are true reflection of the taxonomical and ontological relationships that exist in the data and the classes, as this information is further utilized during the auto-annotation process. MasterList does not limit the depth of the hierarchical relationships, and it can be defined to any level. If there is no hierarchy present among the classes/nodes, the depth is assumed to be 1.

Topic Modelling: Topic Modelling provides a set of latent topics and their associated keywords from a textual dataset. This helps users in identifying disjoint classes as MasterList Nodes.

Validation: A process of user verification of the paragraphs that the DataNeuron platform provides to the users in stage 1 and stage 2 with a list of annotated paragraphs that are most likely to belong to the annotated class.

Word Cloud: Word Cloud helps users quickly obtain the idea of important features/words that can be used to describe the Nodes.

Workflow: A single complete end to end flow starting from uploading file to the final deployment of the model.

Workflow Versioning: A set of features to provide flexibility to users to create multiple versions of the same project to support improvement over the existing flow and switch over these flows as per user decision.

### Example Systems and Methods

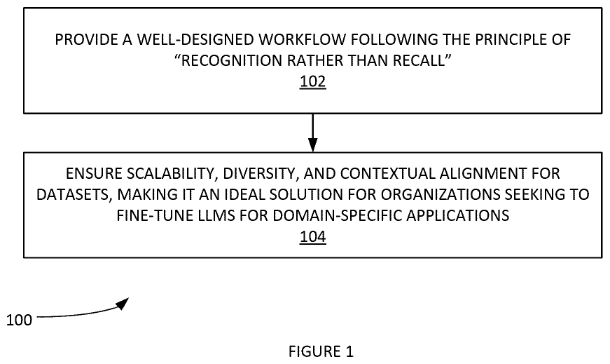

FIG. 1 illustrates an example process 100 for implementing an automated and scalable system for annotating and curating high-quality domain-specific datasets for ML model training and LLM fine-tuning with minimal human supervision, according to some embodiments. In step 102, process 100 provides a well-designed workflow following the principle of “Recognition rather than Recall”. This workflow automates data curation/annotation and minimizes the need for human-in-the-loop (HITL) validation. Process 100 can reduce human effort in data curation by up to 95% without compromising on the quality or relevance of the resulting datasets. In step 104, process 100 ensures scalability, diversity, and contextual alignment for datasets, making it an ideal solution for organizations seeking to fine-tune LLMs for domain-specific applications.

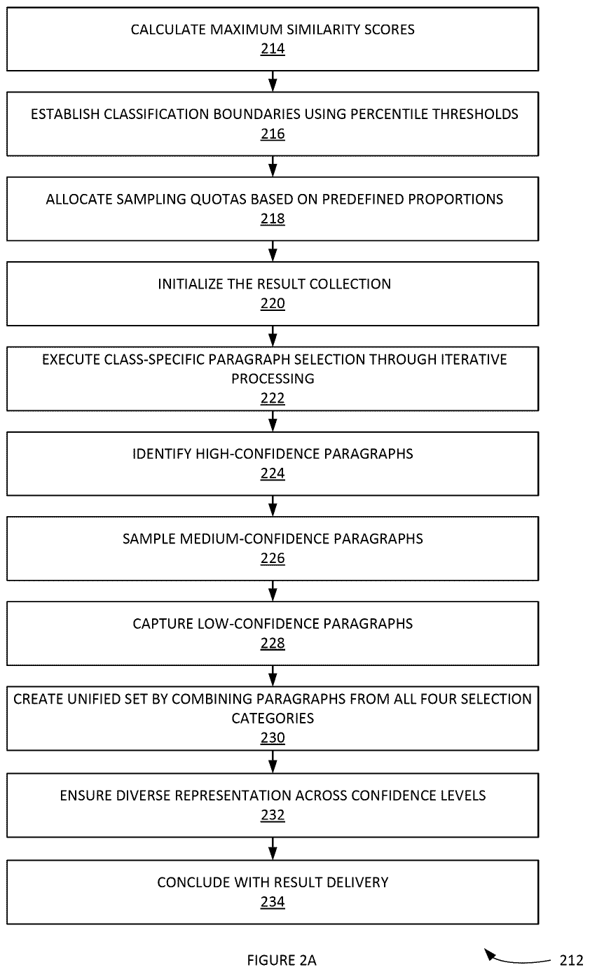

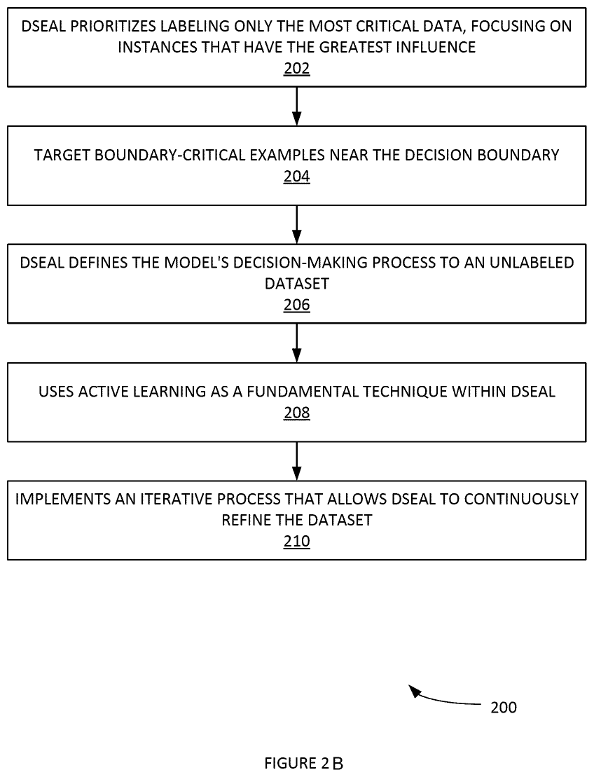

FIG. 2A illustrates an example process 212 for Divisive Sampling for classical NLP use cases, according to some embodiments. Process 212 implements a strategic sampling technique for natural language processing applications. This process ensures efficient data annotation by selecting diverse and critical data points that maximize model performance while minimizing human validation effort. In step 214, process 212 begins with the calculation of maximum similarity scores. Process 212 processes a similarity score matrix containing P paragraphs and C classes, computing the maximum similarity score for each paragraph across all possible classes. This produces a vector containing the highest similarity score for each paragraph.

In step 216, process 212 establishes classification boundaries using percentile thresholds. Process 212 calculates an upper boundary at a predefined high percentile and a lower boundary at a predefined low percentile of the maximum similarity scores. These boundaries effectively segment paragraphs into confidence regions. In step 218, process 212 allocates sampling quotas based on predefined proportions. Process 212 determines how many paragraphs to sample from each confidence region by multiplying the requested output size by predefined fractions, ensuring at least one paragraph is selected from each region. In step 220, process 212 initializes the result collection. Process 212 creates an empty dictionary that will eventually store the selected paragraphs for each class in the masterlist.

In step 222, process 212 executes class-specific paragraph selection through iterative processing. For each class in the masterlist, process 212 identifies and selects paragraphs across four distinct categories, as now discussed. In step 224, process 212 identifies high-confidence paragraphs. Process 212 selects paragraphs with maximum similarity scores above the upper boundary threshold where the predicted class matches the current target class. In step 226, process 212 samples medium-confidence paragraphs. Process 212 selects paragraphs with maximum similarity scores between the upper and lower boundaries where the predicted class matches the current target class. In step 228, process 212 captures low-confidence paragraphs. Process 212 selects paragraphs with maximum similarity scores below the lower boundary threshold where the predicted class still matches the current target class.

In step 230, process 212 identifies explicit class mentions. Process 212 selects additional paragraphs that explicitly mention the current class but were not selected in previous steps, providing a complementary selection method. In step 232, process 212 combines the selected paragraphs. For each class, process 212 creates a unified set by combining paragraphs from all four selection categories, ensuring diverse representation across confidence levels. In step 234, process 212 concludes with result delivery. Process 212 returns the final dictionary containing N strategically sampled paragraphs for each class in the masterlist, providing an optimized dataset for validation and model training.

FIG. 2B illustrates an example process 200 for Divise Sampling And Ensemble Active Learning (DSEAL), according to some embodiments. It noted that existing methods may involve either labeling or validation of every data point in a dataset, which is time-consuming and inefficient. Instead of treating all data points equally, in step 202, DSEAL prioritizes labeling only the most critical data, focusing on instances that have the greatest influence on model performance. In step 204, process 200 targets boundary-critical examples near the decision boundary so that DSEAL ensures that annotation efforts are concentrated where they can provide the highest value. DSEAL selectively focuses on boundary-critical data.

DSEAL uses the idea that data points closest to the decision boundaries are the most influential in defining the model's decision-making process to an unlabeled dataset, where the decision boundaries are not explicitly known in step 206. In step 208, process 200 uses active learning as a fundamental technique within DSEAL. By focusing on these uncertain data points, often located near the decision boundaries, active learning ensures that the model's understanding is enhanced where it matters most. In step 210, process 100 implements an iterative process that allows DSEAL to continuously refine the dataset, minimizing manual effort while maximizing the impact of each labeled data point, ultimately improving the model's accuracy and robustness with less annotation.

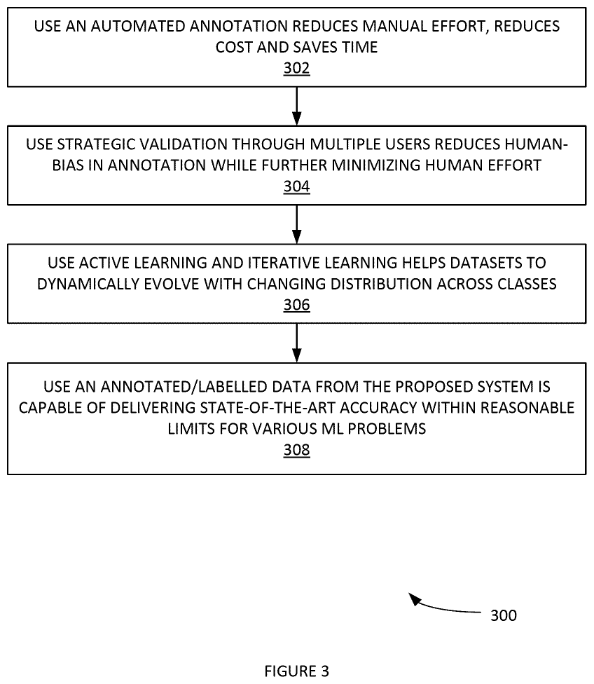

FIG. 3 illustrates an example process 300 for implementing a DataNeuron, according to some embodiments. In step 302, process 300 uses an automated annotation reduces manual effort, reduces cost and saves time. In step 304, process 300 uses strategic validation through multiple users reduces human-bias in annotation while further minimizing human effort. In step 306, process 300 uses Active Learning and Iterative Learning helps datasets to dynamically evolve with changing distribution across classes. In step 308, process 300 uses an annotated/labelled data from the proposed system is capable of delivering state-of-the-art accuracy within reasonable limits for various ML problems.

```
  DSEAL for Classical NLP Data Curation is now discussed.
  Input:
  Let P={p1,p2,...,pm} represent the set of paragraphs, where pi is the ith
paragraph.
  Let C={c1,c2,...,cn}represent the set of classes, where cj is the jth class.
  Output:
  Define a mapping function f:P→P(C), where P(C) is the power set of C (the set of
all subsets of C).
  Relationships:
  1. Many-to-Many Relationship:
  Each paragraph pip_ipi can be associated with multiple classes {cj1,cj2,...,cjk},
where k≤n.
  Mathematically: f(pi)={cj1,cj2,...,cjk},for i=1,2,...,m
  2. One-to-Many Relationship:
  A single class cjc_jcj can be linked to multiple paragraphs {pi1,pi2,...,pil} where
l≤m.
  Mathematically: f−1(cj)={pi1,pi2,...,pil}, for j=1,2,...,n.
```

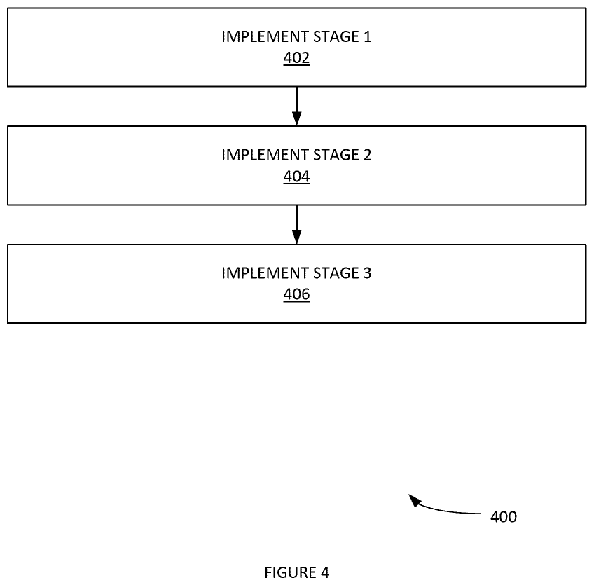

FIG. 4 illustrates an example process 400 for a DataNeuron workflow, according to some embodiments. DataNeuron workflows for automated data labeling consist of three stages. In step 402, process 400 implements Stage 1. Stage 1 implements an initial annotation. Process 400 uses a MasterList containing hierarchical relationships and keywords to auto-annotate data. Strategic sampling is employed to identify key data points, such as boundary-support vectors (BSV) and support vectors (SV), which are crucial for classification. User validation is mandatory, ensuring that the stage produces a robust subset of validated data as a foundation for subsequent stages.

In step 404, process 400 implements Stage 2. Here, semi-automated validation builds upon the validated data from Stage 1. Process 400 utilizes semi-supervised clustering and supervised classification methods in iterative batches. User feedback is incorporated dynamically to refine annotations and improve model accuracy with each batch. This stage significantly reduces manual effort while maintaining user oversight for ambiguous data points.

In step 406, process 400 implements Stage 3. Process 400 implements full annotation and model training, multiple machine learning models, such as Random Forest and SVM, are trained on all validated data. The best-performing model is selected based on metrics like precision and F1 score. This model is then used to extend annotations to the entire dataset, achieving high accuracy while providing detailed performance insights at the node level.

Another example of process 400 is now discussed. This can also be used to supplement steps 402-406 as well in some example embodiments. In Stage 1, process 400 implements Data Preprocessing and Clustering. In this stage, ingested documents are parsed, and the parsed text is broken down into smaller chunks. Embeddings and dimensionality reduction techniques are applied to transform the text, enhancing semantic similarity. Based on this transformation, clusters are formed to group related content.

Data Preprocessing is now discussed. In some examples, ingested documents will be loaded and parsed using libraries such as PyPDF, PDFPlumber, and PartitionPDF etc. Once data extraction is complete, the resulting large chunks will be divided into smaller, more manageable pieces using a semantic chunker and recursive text splitter. This process enhances both efficiency and accuracy, allowing for better handling of precise and relevant data portions. These smaller chunks will then be transformed into vector representations using embeddings like Sentence Transformers embeddings or OpenAI embeddings etc. This transformation improves semantic similarity between the chunks and supports the clustering process, enabling the grouping of related content into distinct clusters.

Clustering is now discussed. By way of example, clustering organizes similar text chunks based on their underlying themes, facilitating the efficient categorization of large datasets. Embeddings are clustered using techniques like K-Means, which groups them into a predefined number of clusters that represent semantically similar text chunks. This structured organization proves valuable for prompt generation, where clusters help create contextually relevant and diverse prompts. By aligning prompts with specific themes from the clusters, this approach enhances clarity, relevance, and user engagement across various applications.

In Stage 2, process 400 implements Strategic Random Sampling and Prompt Generation. From this point onward, the process follows a batch-based approach. In each batch, strategically selected random samples are drawn from different clusters to ensure diversity across datasets and topics. These sampled chunks are then used to generate prompts with LLMs, ensuring a broad representation of the data while maintaining high-quality prompt generation.

In Stage 3, process 400 implements a Filtering mechanism and User validation. Once prompts are generated, their quality is assessed and categorized into intervals based on predefined quality metrics. Samples from each interval are presented for user validation, enabling feedback on the quality and relevance of the prompts. This feedback is then incorporated to refine the prompt generation process for the subsequent batch. The workflow returns to Stage 2, leveraging the user feedback from the first batch to improve the next iteration of prompt generation. Process 400 can iterate until the prompts meet the desired quality standards. After validation, prompts for the entire document set are generated using the finalized batch configuration.

Prompts are now discussed. Prompts can be used for generating responses and are managed in two scenarios:

Case 1: Prompts Generated via DSEAL Prompts created through the DSEAL prompt generation workflow are stored in a MongoDB collection named prompts_data. Each prompt is assigned a unique identifier, PromptId, and includes metadata such as the filename and page number to indicate its source; and

Case 2: Pre-existing Prompts with users If prompts already exist, they must be formatted under a “prompts” section within a CSV file.

Upon upload, process 400 can extract these prompts and store them in the prompts_data collection, applying the same structure and metadata attributes as in the DSEAL workflow.

An example filtering mechanism is now discussed. Filtering Mechanism can be activated from the second batch onward, leveraging feedback from user-disliked prompts. Once new prompts are generated, their quality scores are compared against the scores of the disliked prompts using Euclidean Distance. This approach helps identify prompts that exhibit similar characteristics to the disliked ones and filter them out if they fall within a predefined threshold. Steps in the Filtering Mechanism:
1. Identify Disliked Prompts: Gather all user-disliked prompts from the previous batch. Let the quality scores of these prompts be represented as Qd={q1,q2, . . . , qm}, where m is the number of disliked prompts;
2. Evaluate New Prompts: For every newly generated prompt in the current batch, compute its quality score. Let the scores of these prompts be Qn={p1,p2, . . . , pn} where n is the number of new prompts;
3. Compute Euclidean Distance: The Euclidean Distance between the score of a new prompt pi and a disliked prompt qj is given by:

$$d ( {p}_{i} , {q}_{j} ) = \sqrt{{\sum }_{k = 1}^{N} {( {p}_{i , k} - {q}_{j , k} )}^{2}}$$

Here, pi,k and qj,k represent the score components of pi and qj across N evaluation criteria;
4. Filter Based on Threshold: If the Euclidean Distance d (pi,qj) for any qj∈Qd is less than or equal to a defined threshold τ: d(pi,qj)≤τ Then pi is considered similar to a disliked prompt and is filtered out; and
Iterate for All New Prompts: Repeat the distance computation for all pi∈Qn and compare with Qd to filter out prompts meeting the threshold criteria.

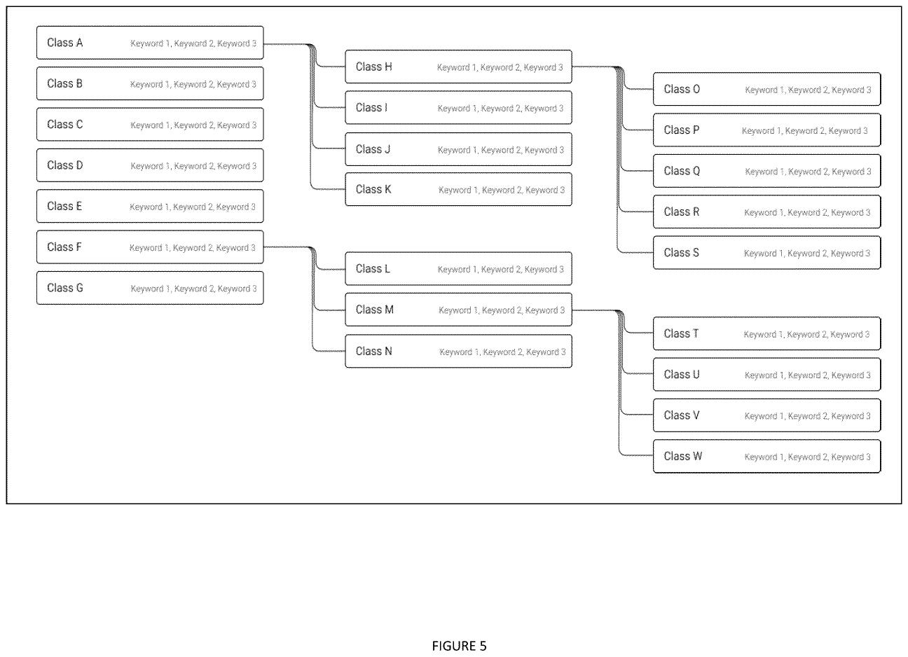

FIG. 5 illustrates an example Master List 500, according to some embodiments. Unlike weak supervisioning methods described in the “Background/Prior Art” section supra, the processes provided herein (e.g. a DataNeuron process, process 400, etc.) can employ a Master List 500 which does not use any labelling function or other complicated rules. Any prior/basic model is not required to initiate the annotation process sample masterlist structure. For each class/node the user needs to define some keywords which are used in identifying that class. A Dynamic MasterList is now discussed. A Dynamic MasterList includes following features: i. Root Node: The node at the top of the hierarchy;
ii. Leaf Node: The last node of each branch when the Masterlist is viewed as a tree structure;
iii. Keywords: A Node is often described with a set of Keywords that can help in identifying the paragraph/data-points which belong to a particular class. The keywords essentially aid in better understanding of the class. Ideally the keywords should be added to every node, however, it is essential to add them for model nodes. More keywords assist the algorithm in annotating a broader range of paragraphs.

An example MasterList related algorithm is now presented. Constants: UPPER_PERCENTILE_BOUNDARY, LOWER_PERCENTILE_BOUNDARY, GROUP_FRACS Input: N=Required number of paragraph in output; M=Similarity Score matrix of dimension P*C for P paragraphs—and C masterlist classes, where an individual score is represented by M[p,c].

```
  Output: A set of N paragraphs for every masterlist class.
  Steps:
  1. max_sim_list = Maximum of array M along the row axis, giving a P-dimensional
vector.
  2. upper_bound = UPPER_PERCENTILE_BOUNDARY's Percentile of max_sim_list
  3. lower_bound = LOWER_PERCENTILE_BOUNDARY's Percentile of max_sim_list
  4. subset_sizes = [max(fraction of N, 1) for fraction in GROUP_FRACS]
  5. result_set = dict( )
  6. for (each class c in masterlist):
  6.1. set1 = {p | (pEP)∧(max(M[p:])>=upper_bound)∧(C[argmax(M[p:])]==c)}
  6.2. subset1 = random_sample of subset_sizes[0] elements from set1
  6.3. set2 = {p |
(pEP)∧(lower_bound<max(M[p:])<upper_bound)∧(C[argmax(M[p:])]==c)}
  6.4. subset2 = random_sample of subset_sizes[1] elements from set2
  6.5. set3 = {p | (pEP)∧(max(M[p:])<=lower_bound)∧(C[argmax(M[p:])]==c)}
  6.6. subset3 = random_sample of subset_sizes[2] elements from set3
  6.7. set4 = {p | (pEP)∧(is_substring(c,p)∧(p∉(subset1∪subset2∪subset3))}
  6.8. subset4 = random_sample of subset_sizes[3] elements from set4
  6.9. result_set[c] = union(subset1, subset2, subset3, subset4)
  7. Output result_set.
```

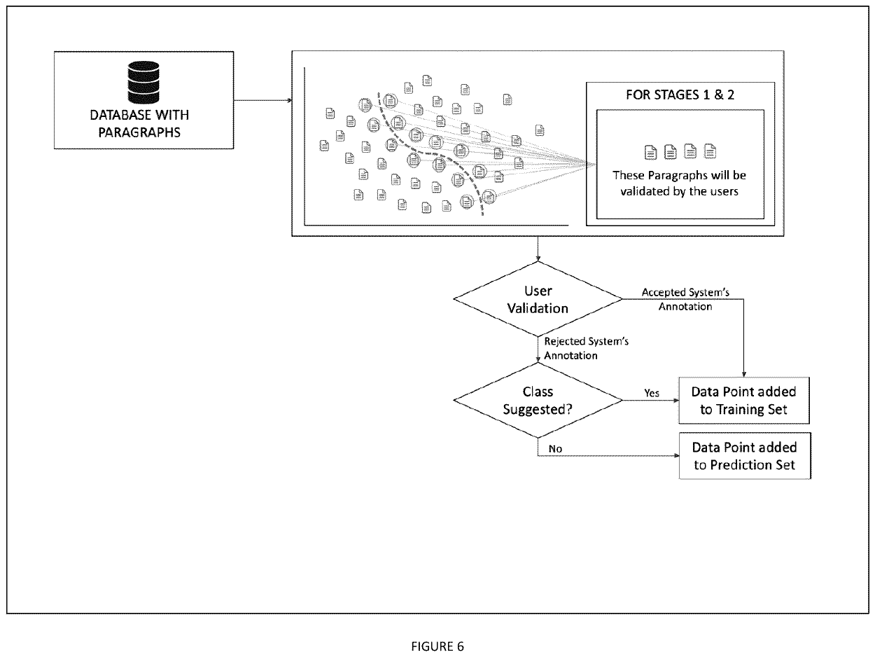

FIG. 6 illustrates an example Visual Concept 600 of Strategic Sampling in Stage 1 and Stage 2, according to some embodiments.

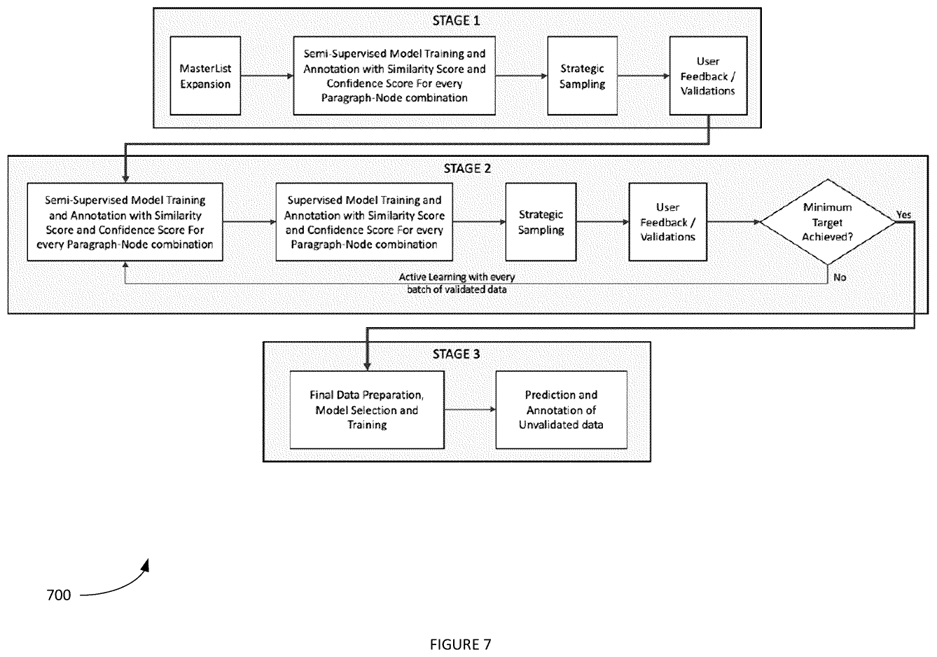

FIG. 7 illustrates an example process 700 for an annotation flow, according to some embodiments. As shown, a DataNeuron automates the annotation/labelling of all the paragraphs/data points that are stored in the database. The Annotation Flow consists of 3 stages. Stage 1 utilizes a MasterList to perform a first round of auto-annotation over a subset of dataset. User Validation is mandatorily required to confirm the auto-annotation performed in Stage 1. Stage 2 utilizes both the MasterList as well as user-feedback from Stage 1 to perform auto-annotation on newer subsets of data across multiple batches. Only some of these data points require user validation while others may become auto-validated. Users have the control to stop Stage 2 annotation-validation after a certain amount of data points are validated. In such a case, they may opt for Stage 3 to expand the annotation and classification to the entire dataset.

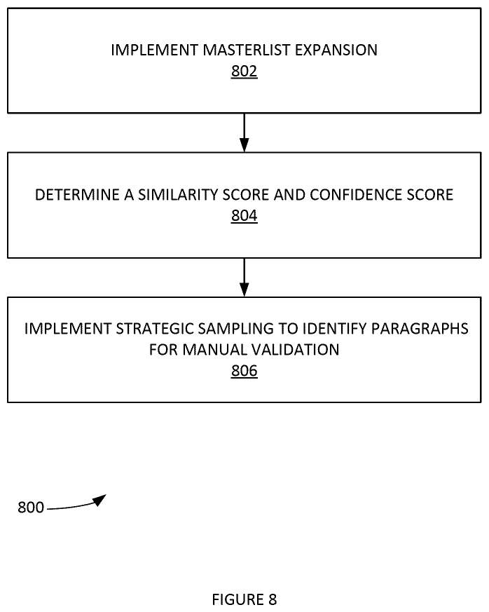

FIG. 8 illustrates an example process 800 for implementing stage 1, according to some embodiments. Stage 1 utilizes the information provided in MasterList to assign class/node to each of the paragraphs collected in the database after Upload and Universal Scraper steps. User feedback is recorded for each of the annotated paragraphs, which is further used in next stages. In step 802, process 800 implements MasterList Expansion. MasterList keywords can be optionally extended using definite synonyms of the already specified keywords for a Node, using a dictionary. This helps in covering more data for which no matching keyword was found in the original list. Another optional approach to use word-embedding based extension of MasterList keywords is also provided.

In step 804, process 800 determines a Similarity Score and Confidence Score. Here, a DataNeuron can use a well-known NLP technique TF-IDF [25] to convert each paragraph as well as every MasterList Nodes to vectors. The dimension of the vector is derived from the vocabulary size of uploaded data, permitted use of n-grams, optional/custom removal of stop words, and minimum thresholding of TF and/or IDF. The Similarity Score is a normalized measurement of Euclidean Distance and Cosine Similarity between a paragraph vector and a Node vector. If two paragraph vectors are represented as p1 and p2, process has:

Simple Sampling;

Cosine Similarity=cos(θ)=p1·p2/∥p1∥·∥p2∥;

Euclidean Distance=D=∥p1−p2∥; and

Similarity Score=Sc=α cos(θ)+βD.

A paragraph is loosely said to be associated with a Node (or a class) if it has maximum Similarity Score with respect to that particular Node. Further, a Confidence Score is also calculated to estimate the strength of uniqueness of such relationships. A Paragraph which has high similarity score with only one of the Node, can also have high Confidence of association; a paragraph having high similarity scores with multiple Nodes, will have low Confidence of being associated with any one of them.

In step 806, process 800 implements strategic sampling to identify paragraphs for manual validation. DataNeuron takes inspiration from Support Vector Clustering which emphasizes that instead of every data point, support vectors themselves are sufficient enough to define hyperplanes between clusters. However, if process 800 forces every data point to be either well within a cluster boundary or exactly at the cluster boundary, it is left with no bounded support vectors (BSV) which results in poor clustering. Hence it is important to identify extreme data points (SV and BSV) to get closer to the cluster boundary while also using data points lying well inside the clusters to avoid merging of desired clusters. The confidence Score calculated in the previous step is used to determine whether a data point is SV, BSV or well inside the cluster boundaries.

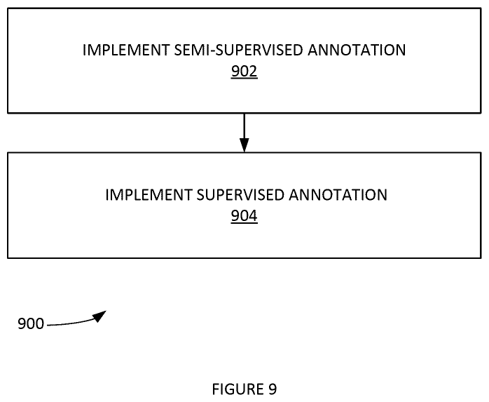

FIG. 9 illustrates an example process 900 for implementing Stage 2, according to some embodiments. Stage 2 starts with the seeds of the paragraphs for each of MasterList Nodes from the validated set of data by users in stage 1. Stage 2 uses Active Learning in batch mode. In every batch a new set of paragraphs (and their associated Nodes) is presented to the user for validation; and a newer/better classification model is created using all validated data acquired till that batch. The process within a batch can be described in following three steps:

In step 902, process 900 implements Semi-Supervised Annotation. All validated paragraphs from Stage 1, and till batch n−1 of Stage 2, are used to create Node vectors. This is in contrast to the Node vectors created in Stage 1, which only used MasterList keywords. These Node vectors are used as initial cluster centers and clustering is performed over all unvalidated paragraphs' vectors. Node vectors or cluster centers are updated in every iteration of clustering. Finally, all the unvalidated paragraphs are assigned to their nearest cluster center, or MasterList Node and the Similarity Score between each (e.g. unvalidated) paragraph vector and corresponding Node vector (e.g. cluster center vector) is calculated using the approach described in Stage 1.

In step 904, process 900 implements Supervised Annotation. The second step in this stage is to use Supervised Learning techniques to build a classifier using the validated set of data from Stage 1. The model created in this step is not a very generalized model in the beginning, due to insufficiency of the training data. However it serves as a base classifier and is used again to associate every (e.g. unvalidated) paragraph to a node with some probabilities (e.g. reflection of Confidence Score in supervised models). Moreover, with every batch of validation a newer model is created, which starts reflecting generalized behavior as we move towards higher batches.

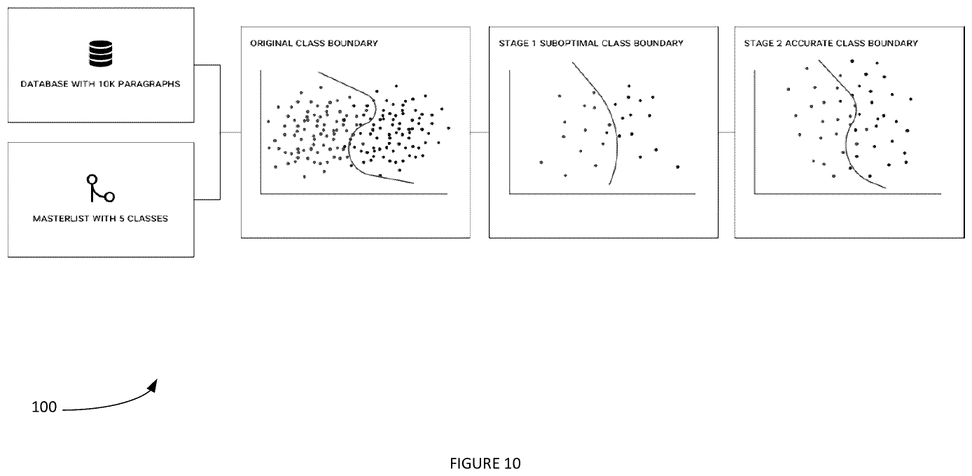

FIG. 10 illustrates an example process 1000 for generalization of a model from Stage 2, according to some embodiment. The class boundary becomes more accurate after each batch in Stage 2 as the model learns from more and more data across batches.

Returning to process 900, in step 906, process 900 can perform Strategic Sampling. Here, process 900 can strategically sample the paragraphs from unvalidated data to get them validated from the users. However in this stage, in every batch, there are two associations of every paragraph with the MasterList Nodes—one using a semi-supervised approach and another using supervised approach. For some of the paragraphs, both of these associations can be with the same Node in MasterList; for some paragraphs it can be with two different Nodes. Process 900 can use an exponentially smoothed factor to sample data from both kinds of associations. In some embodiments, this initially starts with a higher fraction of data from the Semi-Supervised approach and gradually decreases this fraction in subsequent batches. It also applies the same technique as described in Stage 1 for sampling data points which are probable SV, BSV or well inside the class boundaries.

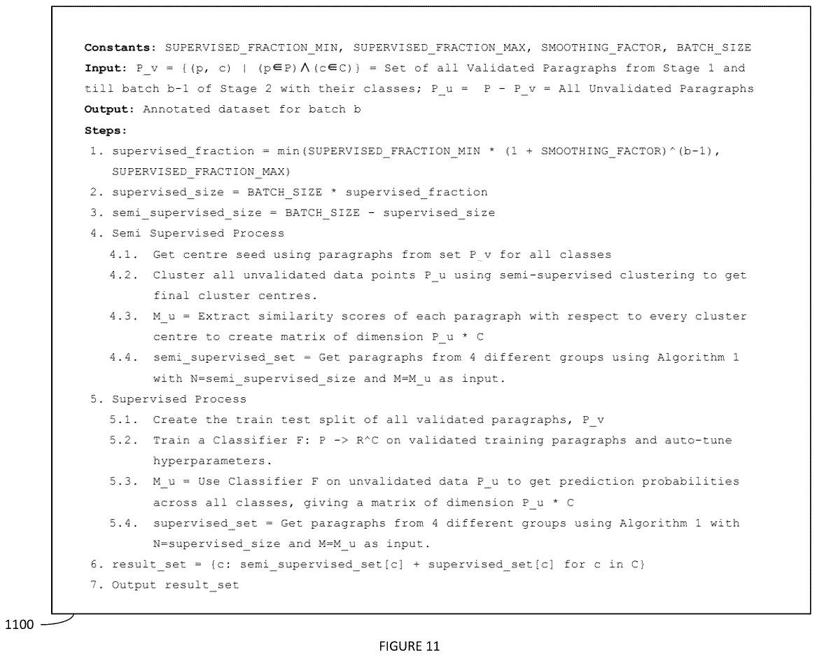

FIG. 11 illustrates an example screenshot Semi-Supervised & Supervised Annotation and Strategic Sampling in a single batch of Stage 2, according to some embodiments.

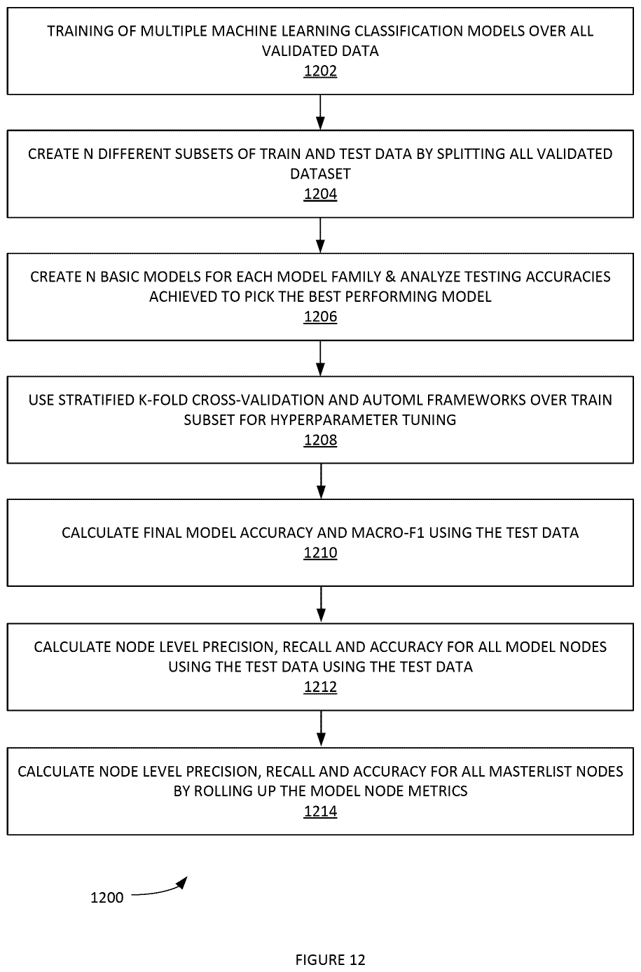

FIG. 12 illustrates an example process 1200 for implementing Stage 3, according to some embodiments. It is noted that Stage 1 and Stage 2 are sufficient for annotating the data. Stage 2 specifically extends to an unlimited number of batches pulling all the paragraphs ultimately for users' validation, if the users intend to do so. However, after a few batches, processes herein can being to suggest if the already validated dataset is sufficient enough to algorithmically decide classification boundaries, and if annotation can be automatically extended to unvalidated dataset with reasonable accuracy. If users opt for auto-extension of annotation to unvalidated dataset, they can trigger the final model training.

Stage 3 starts with training of multiple machine learning classification models over all validated data in step 1202. Process 1200 can use standard sklearn libraries to train models from these families: Decision Tree, Random Forest, Logistic Regression, Naive Bayes, Support Vector Machines and Gradient Boosting Machines. Further, following steps are performed to obtain the final model in Stage 3. In step 1204, process 1200 creates N different subsets of train and test data by splitting all validated dataset using sklearn method sklearn.model_selection.train_test_split( ) for each of the model families.

In step 1206, process 1200 creates N basic models for each model family and analyzes the testing accuracies achieved to pick the best performing model along with its train and test subsets. In step 1208, process 1200 uses Stratified K-Fold Cross-Validation and AutoML frameworks over train subset for hyperparameter tuning of best performing model. In step 1210, process 1200 calculates final model accuracy and macro-F1 using the test data. In step 1212, process 1200 calculates Node level precision, recall and accuracy for all Model Nodes using the test data. In step 1214, process 1200 calculates Node level precision, recall and accuracy for all MasterList Nodes by rolling up the Model Node metrics.

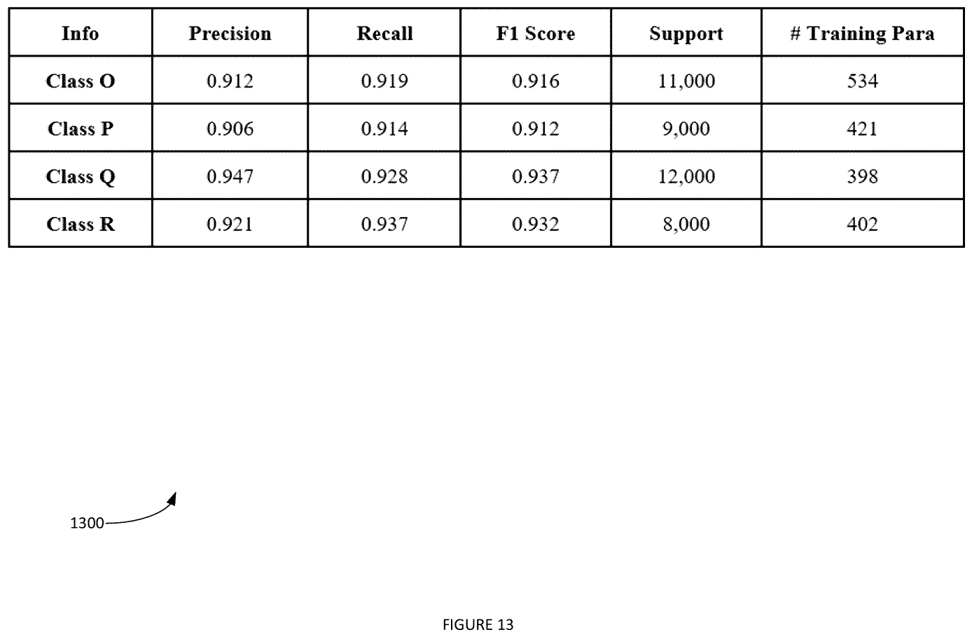

FIG. 13 illustrates an example output table 1300 showing an example result after final model is trained, according to some embodiments. By way of example, table 1300 displays various performance metrics for a classification model. Table 1300 shows various results from the DataNeuron system's classical NLP data curation approach (e.g. as implemented by process 400, etc.). Table 1300 has 6 columns: Info—Headers for different classes (O, P, Q, R); Precision—Showing values around 0.9 (0.912, 0.947, etc.); Recall—Showing values around 0.9 (0.919, 0.914, etc.); F1 Score—Showing values around 0.9 (0.916, 0.912, etc.); Support—Showing the number of samples (11,000, 9,000, etc.); Training Para—Showing the number of training paragraphs (534, 421, etc.). Table 1300 can be used when users analyze the results at Model Node level. Table 1300 shows how process 400 can achieve high precision, recall, and F1 scores (e.g. all above 0.9) while using relatively few training paragraphs compared to the large support numbers. By way of example, for instance, Class O has 11,000 support samples but only needed 534 training paragraphs. This demonstrates the effectiveness of the DataNeuron approach with DSEAL (Divisive Sampling and Ensemble Active Learning) methodology, which aims to reduce annotation effort while maintaining high model accuracy—a key claim in the earlier document where experiments showed annotation effort reduction of up to 95% while maintaining comparable performance to state-of-the-art methods.

It is noted that process 400 supports the iterative training through WorkFlow Versioning (e.g. as provided in step 402) if the results do not appear satisfactory to users. Once final model is trained using the processes provided supra, the users can analyze the results at Model Node level as illustrated in output table 1300.

In one embodiments, users have two options. In a first option, a user can re-define the MasterList of process 400 and start from Stage 1 (e.g. step 402) again while retaining the paragraphs which were already validated in previous iterations. In a second option, a user can directly start at Stage 2 (e.g. step 404) and validate more paragraphs for the Model Nodes where results are not satisfactory.

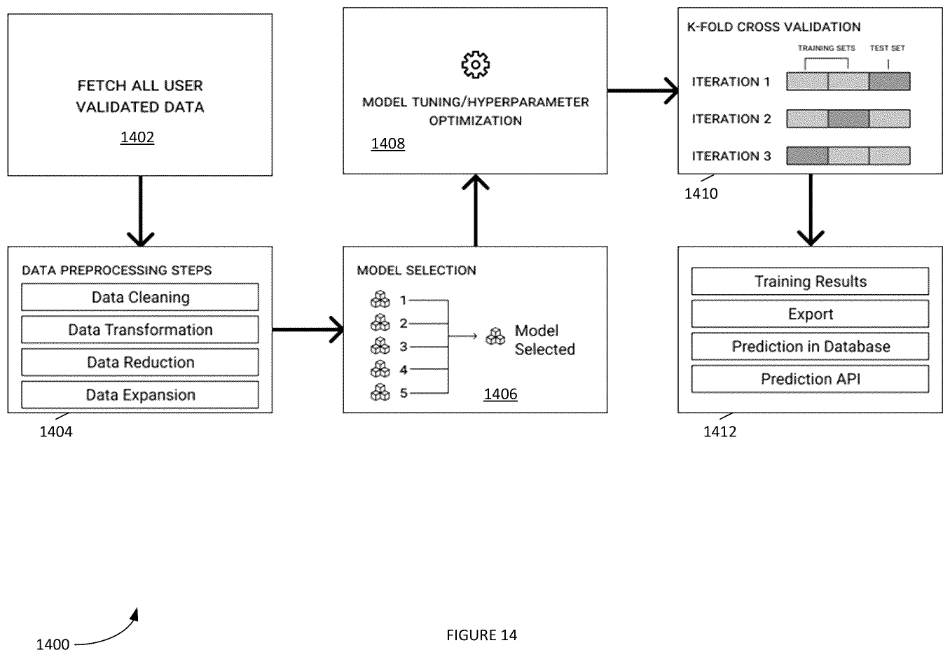

FIG. 14 illustrates an example process 1400 for use a Predict in Database option to extend the annotation to all unvalidated paragraphs, according to some embodiments. Once the desired model is trained and developed, the users can use the “Predict in Database” option to extend the annotation to all unvalidated paragraphs.

FIG. 14 illustrates an example process 1400 for implementing a DataNeuron system's processing workflow, according to some embodiments. Process 1400 can be a complete workflow for a DataNeuron system, showing how data moves through preprocessing, model selection, optimization, and evaluation stages.

In step 1402, process 1400 can fetch all user validated data. Step 1402 can retrieve all previously validated data from users. This aligns with Stage 1 and Stage 2 (e.g. steps 402 and 404) of the DSEAL methodology where users validate auto-annotated data points.

In step 1404, process 1400 performs data preprocessing steps. Steps 1404 shows four preprocessing operations: Data Cleaning, Data Transformation, Data Reduction, and Data Expansion. These can be preparation steps to ensure data quality before model training. The document mentioned the importance of preprocessing for both classical NLP workflows and generative AI applications.

In step 1406, process 1400 performs model selection. This shows multiple model options (labeled 1-5) with “Model Selected” indicated. The DSEAL approach tests multiple machine learning models to find the optimal performer. Various testing models from these families can be utilized, inter alia: Decision Tree, Random Forest, Logistic Regression, Naive Bayes, Support Vector Machines, and Gradient Boosting. Step 1406 can start with training of multiple ML models; it selects the best performing one and further tunes it for obtaining the best predictions over unvalidated dataset.

In step 1408, process 1400 performs model tuning/hyperparameter optimization. Once a model is selected, this step 1408 optimizes its parameters to maximize performance. Process 1400 can use Stratified K-Fold Cross-Validation and AutoML frameworks over train subset for hyperparameter tuning of best performing model.

In step 1410, process 1400 performs k-fold cross validation. Step 1410 shows iterations 1-3, which represent cross-validation testing to ensure model robustness. The document mentioned this process for evaluating model performance.

In step 1412, process 1400 performs model output. This can include the final outputs of the system, inter alia: Training Results; Export; Prediction in Database; Prediction API; etc.

The workflow demonstrates the complete DSEAL methodology from data processing through model selection, optimization, and final deployment. Process 1400 embodies the automated data curation approach described in the document, which aims to significantly reduce manual annotation effort while maintaining high model accuracy.

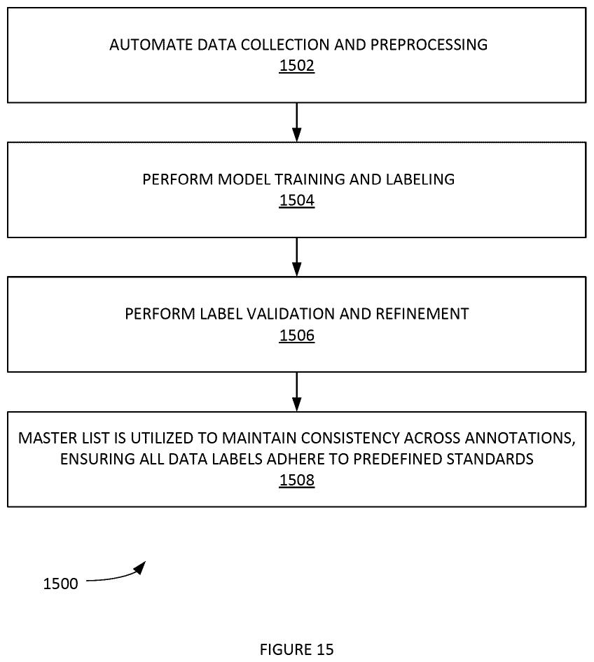

FIG. 15 illustrates an example process 1500 for implementing a DataNeuron's workflow, according to some embodiments. It is noted that traditional data annotation techniques face challenges such as scalability, human error, and inefficiency due to manual labeling. Process 1500 can use a DataNeuron's workflow to address these by automating the process through three key stages. In step 1502, process 1500 automates data collection and preprocessing. In step 1504, process 1500 performs model training and labeling on the output of step 1502. In step 1506, process 1500 performs label validation and refinement on output of 1504. In step 1508, a master list is utilized to maintain consistency across annotations, ensuring all data labels adhere to predefined standards.

Process 1500 can be used to enhance scalability by reducing manual intervention and improving labeling speed. Machine learning algorithms train the model to autonomously generate accurate labels. Validation and refinement ensure high-quality, reliable data. This approach leads to cost savings, faster turnaround, and more efficient data preparation for model training.

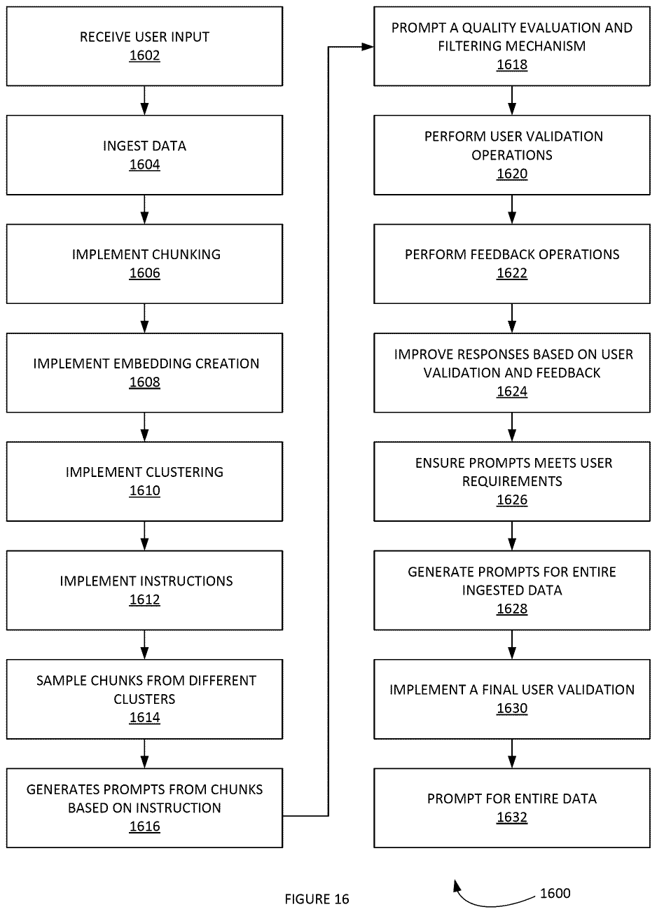

FIG. 16 illustrates an example process 1600 for DSEAL prompt generation workflow, according to some embodiments. In step 1602, process 1600 receives user input. Process 1600 begins with user input, which includes raw text or PDF files to be processed for prompt generation. These files contain the domain-specific information that will form the basis for generating prompts.

In step 1604, process 1600 ingests data. The system ingests the input files, preparing them for processing. This step can handle various file formats and ensure they are correctly loaded into the system for further processing.

In step 1606, process 1600 implements chunking. The ingested text is divided into smaller, more manageable pieces (chunks) using standard chunking methods like semantic chunking and recursive text splitters. Chunking enhances efficiency and accuracy, allowing better handling of precise and relevant data.

In step 1608, process 1600 implements embedding creation. The text chunks are transformed into vector representations using embedding techniques such as Sentence Transformers or OpenAI embeddings. These embeddings help quantify the relationships between text chunks, enabling the grouping of related content.

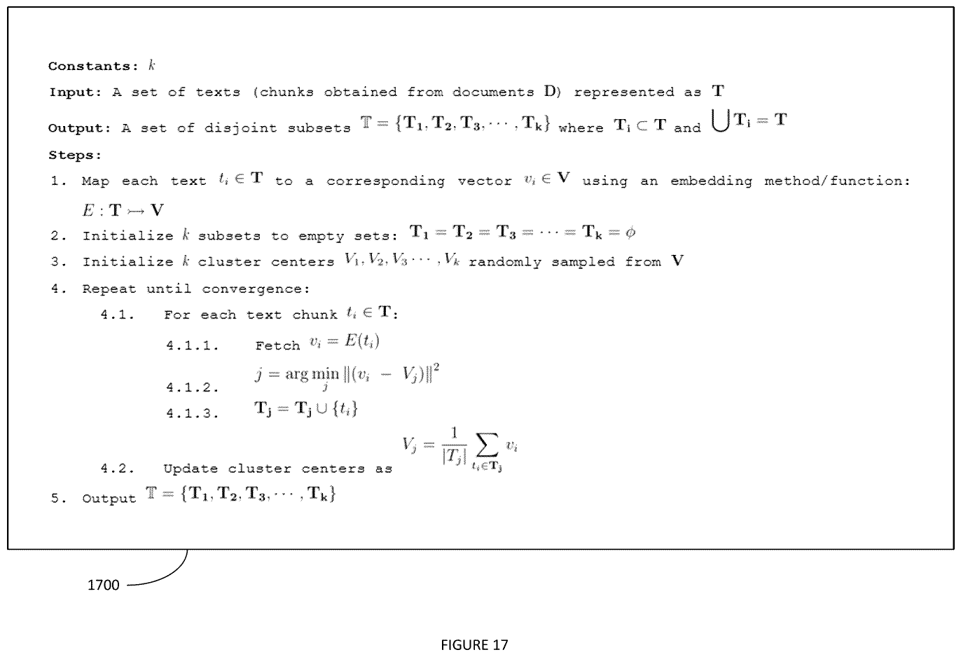

In step 1610, process 1600 implements clustering. Using techniques like K-Means clustering (as shown in FIG. 17), the system organizes the embedded chunks into semantically similar groups. This structured organization facilitates contextually relevant and diverse prompt generation.

FIG. 17 illustrates an example algorithm 1700 for using techniques like K-Means clustering to organize the embedded chunks into semantically similar groups, according to some embodiments.

In step 1612, process 1600 implements instructions. In parallel with the data processing track, the user provides prompt instructions that serve as guidelines to shape the LLM's output for the specific task or domain. In some examples, clear and well-defined instructions ensure the model generates outputs that align with user expectations.

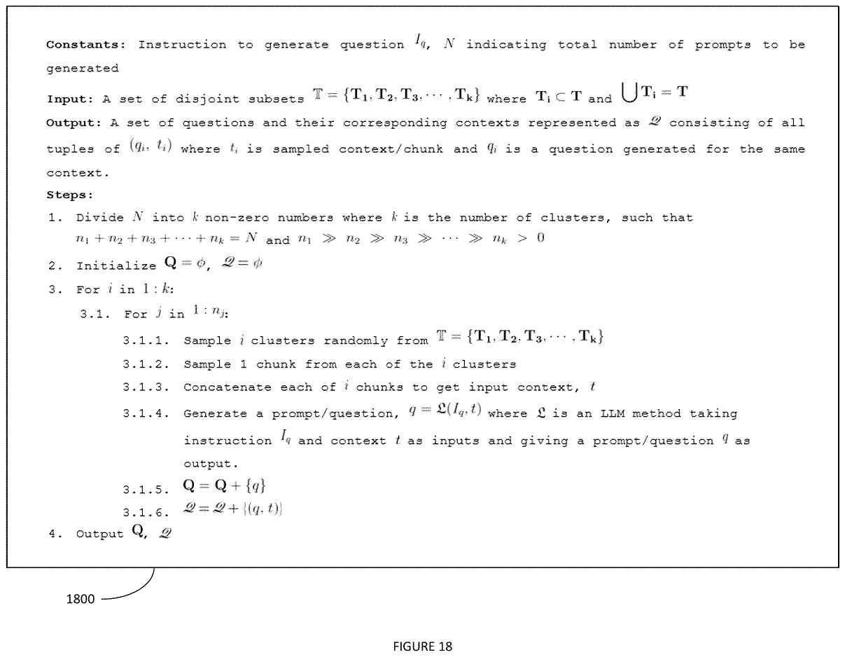

In step 1614, process 1600 samples chunks from different clusters. Using Divisive Sampling (e.g. see FIG. 18, etc.), the system selects a diverse subset of chunks from across different clusters. This ensures that the sampled chunks maintain the diversity that was originally present in the complete dataset. Since a particular cluster might relate to a single underlying theme or topic, the system may combine chunks from multiple clusters to create prompts that span multiple topics.

FIG. 18 illustrates an example algorithm 1800 for using divisive sampling to select a diverse subset of chunks from across different clusters, according to some embodiments. Divisive sampling improves the generation of diverse and relevant prompts by avoiding the limitations of traditional random sampling, which could result in incomplete or monotonous outputs. By balancing the selection across multiple scenarios, it ensures comprehensive coverage of the data, making the results both diverse and meaningful.

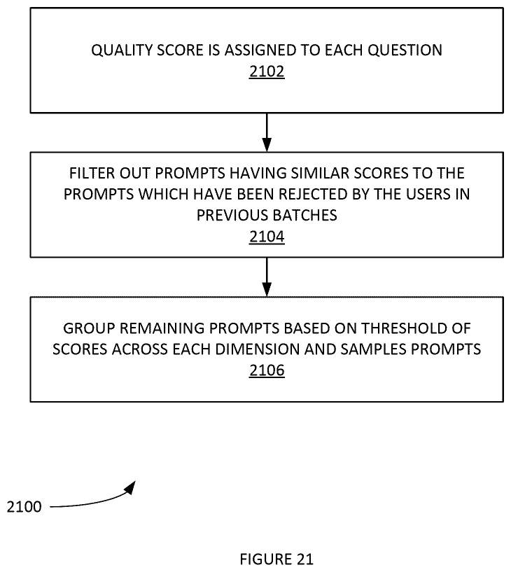

FIG. 21 illustrates an example process 2100 for divisive sampling of prompts, according to some embodiments. Once the prompts are generated, they are further sampled to minimize the validation needed from the users. This sampling is a three-stage process based on the quality evaluation of generated questions through an LLM. In the first stage, step 2102, a quality score is assigned to each question. The second stage, step 2104 is used only from batch two onwards and filters out the prompts having similar scores to the prompts which have been rejected by the users in previous batches. Third stage, step 2106, quality score is assigned to each question filters out the prompts having similar scores to the prompts which have been rejected by the users in previous batches groups the remaining prompts based on threshold of scores across each dimension and samples prompts from each group for user validation. These three stages are described further according to various embodiments.

Prompt Quality Evaluation is now discussed. Process 1600 can assesses the quality of generated question based on following five criteria, inter alia:
Relevance: It measures how closely the prompt aligns with the topic or subject matter. A higher relevance score indicates that the prompt is directly related to the context or issue being discussed;
Simplicity: It refers to how simply the prompt is worded. A high simplicity score means the prompt is easy to understand, with minimal ambiguity. For example, a score of 0.7 suggests the prompt is fairly clear but could benefit from some improvement;
Depth: It evaluates the complexity or thoroughness of the prompt. A high depth score (e.g., 0.9) indicates that the prompt explores the topic in detail, requiring a thoughtful and detailed response;
Originality: It assesses how unique or novel the prompt is. For example, a score of 0.6 suggests the prompt may be somewhat common or lacks a distinctive angle, but still has some originality; and
Completeness: It measures how fully the prompt addresses the topic. For example, a score of 0.8 indicates that the prompt covers most relevant aspects leaving out only a few details or elements.

Each prompt is assigned a score of 0 to 1 against these 5 criteria using an LLM:

Here, represents a vector of scores across relevance ( ), simplicity ( ), depth ( ), originality ( ), and completeness ( ). is the instruction to LLM for scoring the question against the context.

In step 1616, process 1600 generates prompts from chunks based on instruction. The system applies the user's instructions to the sampled chunks to generate prompts using an LLM. For combined chunks, a single question/prompt is generated that spans multiple topics, creating more comprehensive and interconnected prompts.

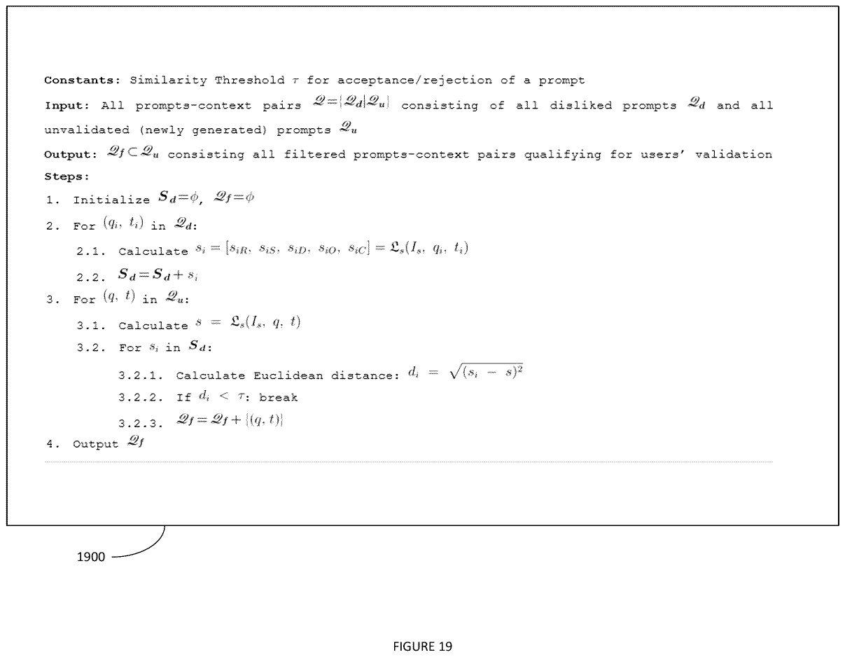

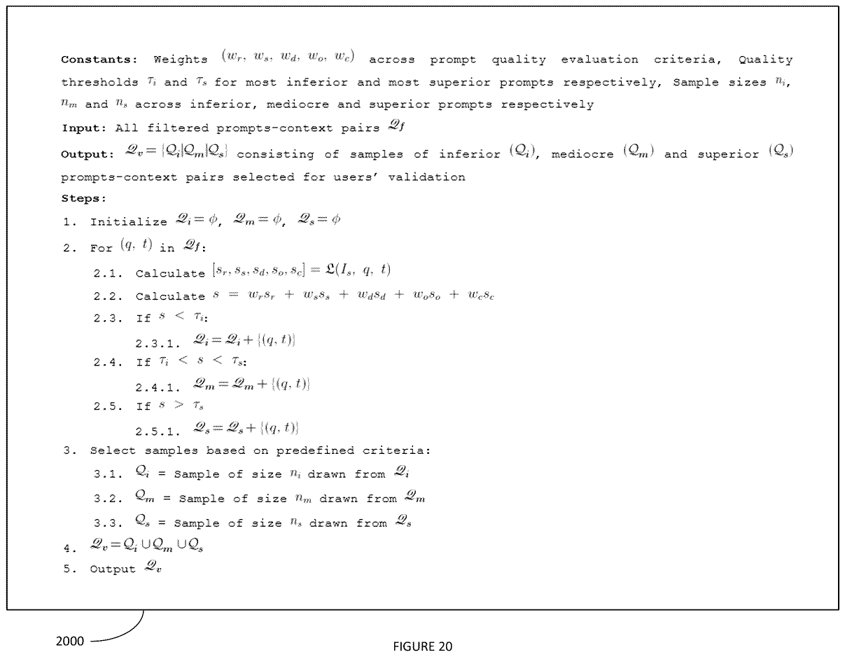

In step 1618, process 1600 prompt a quality evaluation and filtering mechanism. The generated prompts undergo quality evaluation based on five criteria (relevance, simplicity, depth, originality, and completeness), with scores from 0 to 1 assigned to each prompt. From batch two onwards, the system also filters out prompts exhibiting similar characteristics to those previously disliked by users (e.g. see FIG. 19, etc.). The remaining prompts are grouped based on quality score thresholds and sampled for user validation (e.g. see FIG. 20, etc.).

FIG. 19 illustrates an example algorithm 1900 for prompt filtering based on their quality scores, according to some embodiments. Filtering Mechanism can leverage the feedback from user-disliked prompts from second batch onwards to filter out certain prompts exhibiting similar characteristics to the disliked ones. This reduces the unnecessary effort needed from users during prompt validation. Algorithm 1900 describes the steps in the filtering mechanism.

FIG. 20 illustrates an example algorithm 2000 for sampling and final selection of prompts for users' validation within a batch, according to some embodiments. Prompt quality segmentation and sampling are now discussed. While filtering provides a basic rejection of prompts which are a certain misfit to users' requirements, many prompts could still qualify for users' validation process. Process 1600 applies another round of Divisive Sampling to ensure that users focus on the prompts that really need their attention. Algorithm 2000 describes the sampling and final selection of prompts for users' validation within a batch.

In step 1620, process 1600 performs user validation operations. Users validate the sampled prompts by providing feedback through “like,” “dislike,” or “edit” options. This step is crucial for understanding user preferences and identifying effective prompts.

In step 1622, process 1600 performs feedback operations. The system captures user feedback, which is essential for improving future prompt generation. This feedback helps the system understand which prompts are more effective and how to adjust generation parameters.

In step 1624, process 1600 improves responses based on user validation and feedback of each step. The system applies an ensemble of active learning approaches to improve prompt generation, including “improvement of instructions,” “few-shot examples,” and “adjustment of thresholds and weights for filtering and sampling mechanisms.” This creates a continuous learning loop where each batch improves upon the previous one.

In step 1626, process 1600 ensures prompts meet user requirements. After several iterations of the feedback loop, the system checks whether prompts consistently meet user expectations. If they do, the process continues to the next step; if not, more iterations of generation and validation are performed.

In step 1628, process 1600 generates prompts for entire ingested data. Once prompt quality meets user requirements, the system applies the optimized configuration to generate prompts for all chunks across the entire dataset. This ensures comprehensive coverage of the ingested data.

In step 1630, process 1600 implements a final user validation. Users conduct a final validation of the generated prompts to ensure they align with expectations across the entire dataset. This step provides a last opportunity for quality control before the prompts are finalized.

In step 1632, process 1600 prompts for entire data. The final output consists of a complete set of validated prompts covering the entire ingested dataset, ready for use in applications such as fine-tuning LLMs, creating Q&A systems, or other generative AI tasks.

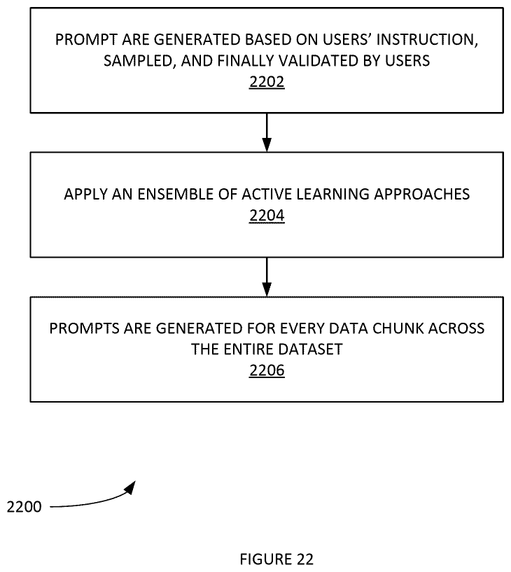

FIG. 22 illustrates an example process 2200 for ensemble active learning, according to some embodiments. User validation and feedback can be important components of the prompt generation process. In every batch, the prompts are generated based on users' instruction, sampled, and finally validated by users in step 2202. In some examples, users can either “like”, or “dislike”, or “edit” them. This feedback helps the process 2200 understand the user's preferences and identify which prompts are more effective. From one batch to another, process 2200 applies an ensemble of active learning approaches in step 2204. This can include “improvement of instructions”, “few-shot examples”, and “improvement of thresholds and weights of filtering as well as sampling mechanisms”. Once the refined prompts consistently meet users' expectations, users can opt for a full-scale generation of prompts. At this stage, based on predefined configurations, prompts are generated for every data chunk across the entire dataset in step 2206. Process 2200 ensures that the prompts are both contextually accurate and aligned with users' requirements.

Additional example embodiments are now discussed. These can be used in implementing various steps discussed supra. Data Preprocessing DataNeuron workflows can start with the assumption that documents are available in raw text format. In case, data/text needs to be extracted from PDF files, parsing libraries (e.g. PyPDF, PDFPlumber, and PartitionPDF etc.) can be used. The exact usage of these libraries and discussions around their efficiency or accuracy are outside the scope of the proposed solution.

Once data is available as a large raw text, it is divided into smaller, more manageable pieces using a semantic chunker and recursive text splitter. Chunking enhances efficiency and accuracy, allowing better handling of precise and relevant data. These smaller chunks can then transformed into vector representations using embeddings like Sentence Transformers embeddings or OpenAI embeddings, etc. Embeddings can help in quantifying the relationships across the text chunks, enabling the grouping of related content required in the subsequent steps.

Prompt Generation algorithms can be used in example implementations of chunk sampling and prompt generation in detail. In summary, the chunk-vectors are sampled from VectorDB and/or an LLM is used to generate the prompts with these chunks. Some of the chunks might be joined together to create a wider scope of context and generate deeper and cross-topic questions/prompts. Prompt Generation can utilize example DSEAL technique(s) (and/or iterative/active learning) to ensure diversity across dataset and topics. Once the user is satisfied with the prompts generated across these sampled chunks (e.g. which can itself take multiple mini-iterations to improve instruction and LLMs hyperparameters), a new set of samples are generated. The process continues until the user triggers the mass generation of all prompts across all chunks (e.g. and/or ingested documents).

Filtering mechanisms and user validation prompt validation with DSEAL can uses another level of strategic sampling to select the critical prompts which are validated with the user. Hence even from the sampled chunks in the previous step, a lot more prompts are generated by varying LLMs' hyperparameters/settings and their quality and relevance is assessed. Based on certain quality metrics, the prompts are sampled to get the user validation. The user's feedback collected in this manner helps the system learn quicker the desired behavior from LLMs and shortens the learning cycles across batches.

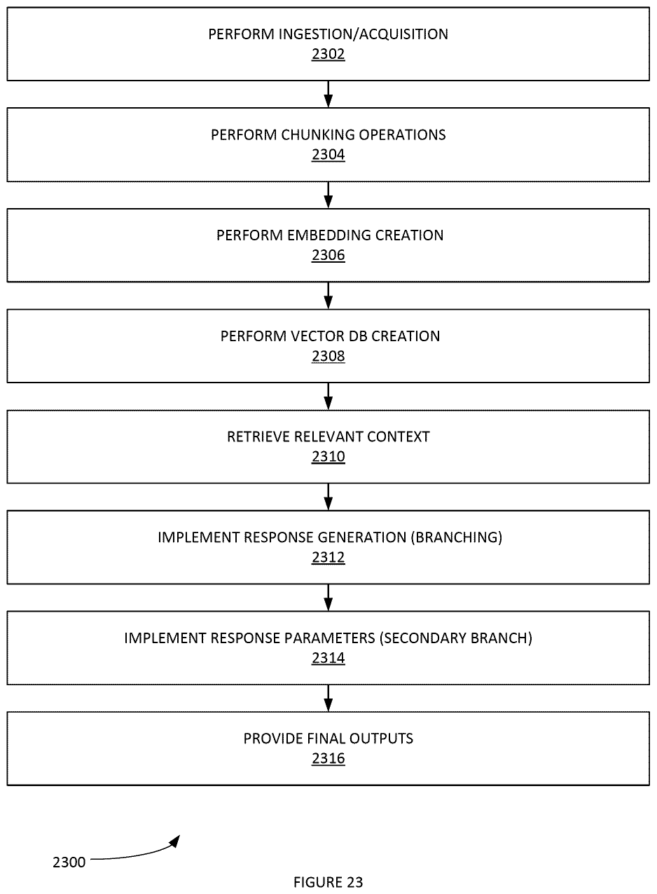

FIG. 23 illustrates an example process 2300 for DSEAL response generation, according to some embodiments. In step 2302 process 2300 performs ingestion/acquisition. Process 2300 can begin with document ingestion or acquisition, where raw content files are input into the system. These documents contain domain-specific information that will be used to generate responses.

In step 2304, process 2300 performs chunking operations. Process 2300 divides the ingested documents into smaller, manageable pieces using standard chunking methods. This enables more precise processing and retrieval of relevant content segments.

In step 2306, process 2300 performs embedding creation. The text chunks are transformed into vector representations using embedding techniques. These embeddings capture semantic relationships between content pieces, enabling efficient similarity comparisons and retrieval.

In step 2308, process 2300 performs Vector DB creation. The embedded chunks are stored in a vector database, which organizes the content for efficient retrieval. This database enables quick similarity searches to find relevant information for responding to prompts.

In step 2310, process 2300 retrieves relevant context. When a prompt/question is received, the system queries the vector database to retrieve the most relevant context chunks. This step connects user queries to the appropriate information sources.

In step 2312, process 2300 implements response generation (branching). This step branches into two parallel processes. The primary response generation based on the prompt and retrieved context. Retrieving prompt-specific parameters for customized response generation.

In step 2314, process 2300 implements response parameters (secondary branch). Process 2300 determines appropriate parameters for response generation based on the prompt type, including aspects like response length, detail level, and style considerations.

In step 2316, process 2300 provides final outputs. Process 2300 produces final outputs, combining the generated response with appropriate formatting based on the specified parameters. These responses are delivered to users as the end product of the workflow.

This process implements DSEAL methodology for response generation, focusing on efficient retrieval of relevant information and generation of high-quality, contextually appropriate responses with minimal human validation required.

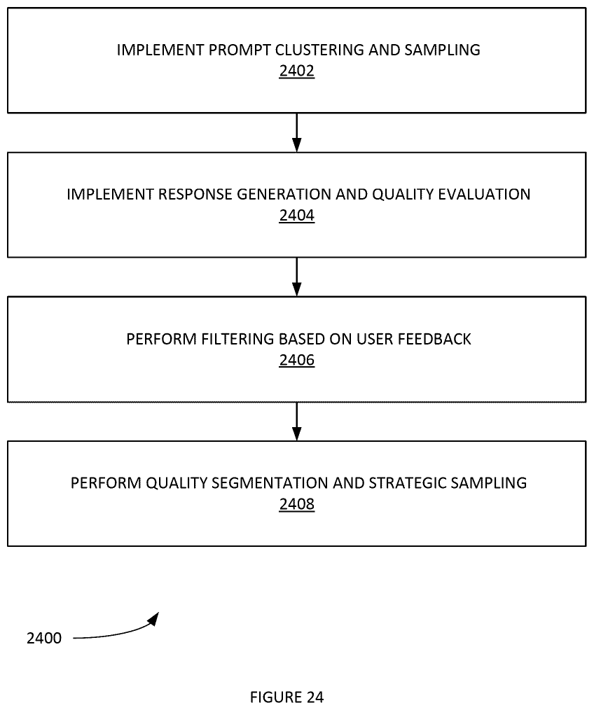

FIG. 24 illustrates an example process 2400 for divisive sampling for response generation, according to some embodiments. In step 2402, process 2400 implements prompt clustering and sampling.

Divisive sampling for response generation begins with a focus on optimizing efficiency while maintaining generalizability. In this first phase, prompts are clustered and sampled to provide a diverse foundation for generating responses.

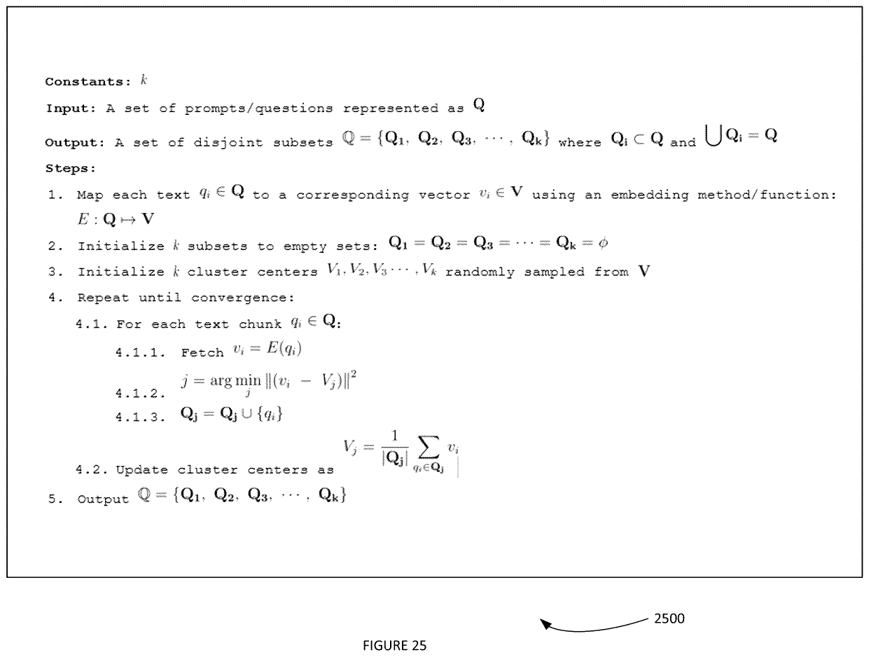

The process uses K-Means clustering (e.g. see FIG. 25, etc.) to organize prompts based on semantic similarity. Each prompt is mapped to a corresponding vector using an embedding method, with cluster centers initialized randomly. Through iterative refinement, the prompts are grouped into disjoint subsets representing semantically similar questions.

FIG. 25 illustrates an example algorithm 2500 for K-Means clustering of questions/prompts, according to some embodiments. This clustering approach helps organize diverse prompts into meaningful groups based on their semantic similarity. In the context of divisive sampling for response generation, this clustering ensures that when sampling prompts, a user can select from across different semantic clusters—guaranteeing that a sample represents the full diversity of question types and topics in a dataset.

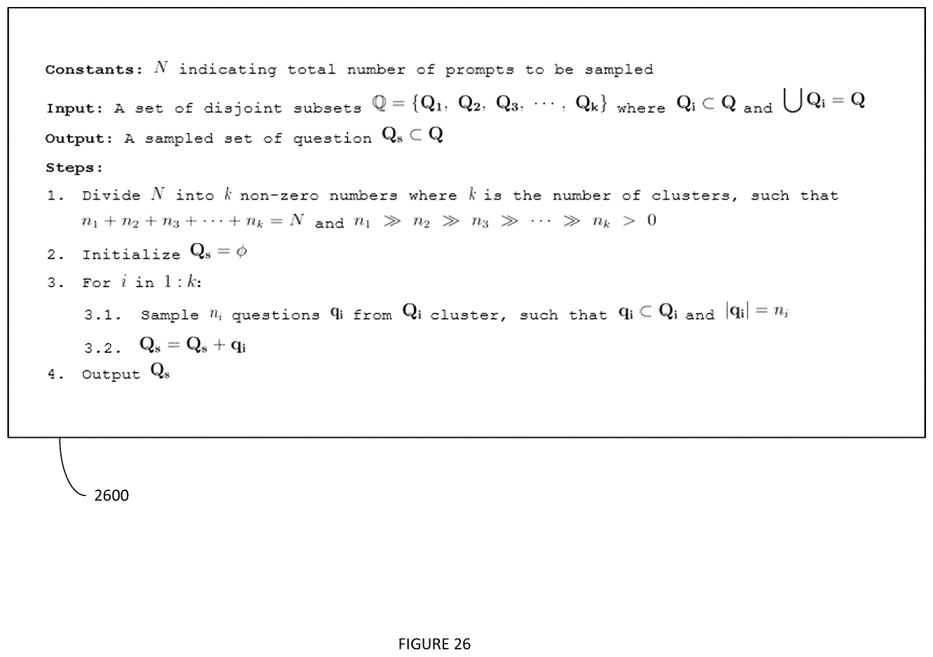

Following a clustering algorithm (e.g. see FIG. 26, etc.), process 2400 implements straightforward random selection across each cluster. This sampling approach divides the total number of desired prompts into non-zero allocations across clusters, with larger allocations for more significant clusters. For each cluster, the algorithm samples the specified number of questions, ensuring the resulting set maintains the diversity of the original data while optimizing for coverage of the entire prompt space.

FIG. 26 illustrates an example algorithm 2600 for divisive sampling of prompts for response generation, according to some embodiments. This algorithm strategically samples prompt from different clusters to ensure diversity in the selected dataset. It distributes the total number of desired prompts across clusters (e.g. allocating more samples to larger or more important clusters), then randomly selects the specified number of questions from each cluster. The resulting sample maintains the diversity of the original dataset while using a smaller, more manageable number of prompts for response generation and evaluation.

This strategic selection ensures that the sampled prompts have maximum variance and diversity, enabling the system to learn a generalizable configuration for all uploaded or connected prompts.

In step 2404, process 2400 implements response generation and quality evaluation. Once prompt sampling is complete, the system generates and evaluates responses using the retrieved context and LLM capabilities. For each sampled prompt, an information retrieval system fetches the most relevant chunks from the vector database. These chunks are concatenated into a single context, which is then passed to an LLM along with the prompt and appropriate instructions. The system may use the most sophisticated LLM available for this step to ensure maximum accuracy, regardless of which model will be used for deployment.

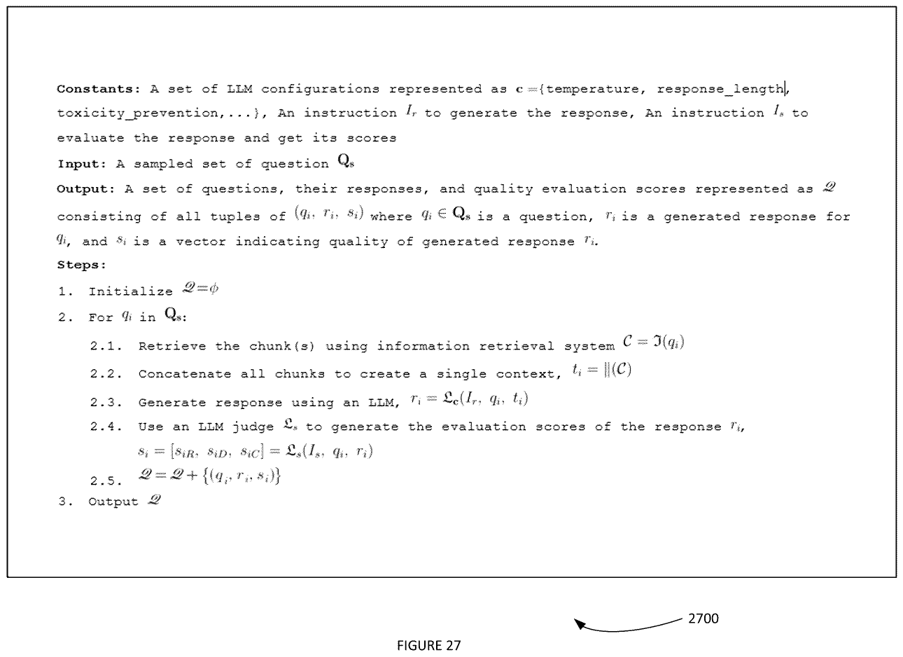

FIG. 27 provides an algorithm 2700 that outlines this process in detail. The system takes a set of LLM configurations (e.g. including parameters like temperature and response length), along with instructions for generation and evaluation. For each prompt, it retrieves relevant context, generates a response using the specified LLM configuration, and then evaluates the quality of that response.

FIG. 27 illustrates an algorithm 2700 for response generation and evaluation of their quality scores, according to some embodiments. Algorithm 2700 generates high-quality responses for sampled prompts by retrieving relevant context chunks from a vector database and using them with configured LLM parameters. For each prompt, it generates a response using the retrieved context and then evaluates that response's quality using an LLM judge across dimensions like relevance, depth, and correctness. The final output is a comprehensive set of tuples containing prompts, their generated responses, and quality evaluation scores that can be used for further filtering and user validation. Quality evaluation is performed by an LLM Judge across three critical dimensions:

Relevance: How directly the response addresses the specific question;

Depth: The thoroughness and detail of the response; and

Correctness: The factual accuracy and reliability of the information provided.

Each prompt-response pair can receive scores from 0 to 100 on these dimensions, creating a comprehensive quality profile for each generated response.

In step 2406, process 2400 can perform filtering based on user feedback.

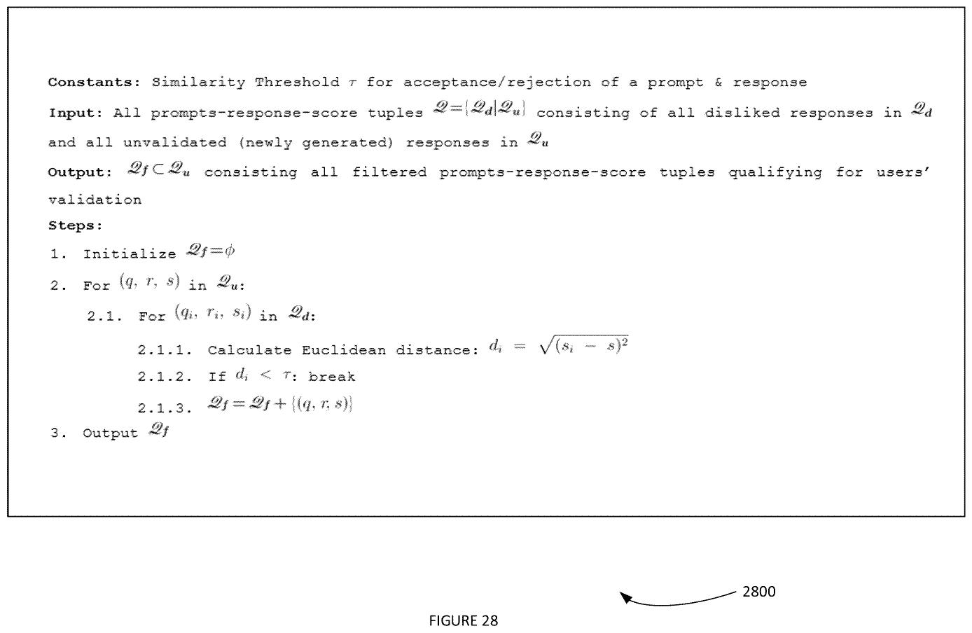

The third step focuses on leveraging user feedback to filter out responses with characteristics similar to previously rejected content. Starting from the second batch, an algorithm (e.g. see FIG. 28, etc.) implements a filtering mechanism that compares newly generated responses against those previously disliked by users. For each new prompt-response-score tuple, the system calculates the Euclidean distance between its quality scores and those of disliked responses from previous batches. If this distance falls below a specified similarity threshold, the response is excluded from further consideration.

FIG. 28 illustrates an example algorithm 2800 for Response filtering based on their quality scores, according to some embodiments. Algorithm 2800 filters out newly generated responses that are too similar to previously disliked responses, using a similarity threshold as the decision criterion. For each new prompt-response pair, it calculates the Euclidean distance between its quality scores and those disliked responses from previous user feedback sessions. Only responses that are sufficiently different from all previously disliked responses (e.g. based on the similarity threshold) are included in the filtered output set for user validation, effectively reducing redundant validation efforts.

This approach significantly reduces the unnecessary validation effort required from users by automatically filtering out responses likely to be rejected based on historical feedback patterns. Algorithm 2800 outputs a filtered set of prompt-response-score tuples that qualify for user validation, excluding those with characteristics similar to previously rejected responses.

In step 2408, process 2400 performs quality segmentation and strategic sampling. The final step ensures that users focus on validating the most informative and diverse set of responses through strategic sampling across quality segments.

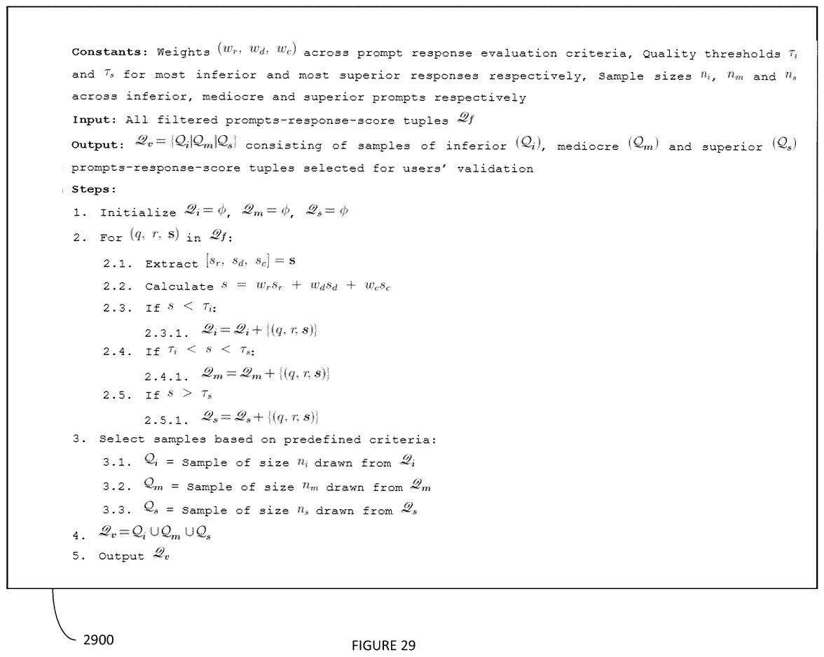

An algorithm (e.g. see FIG. 29, etc.) implements a divisive sampling approach for responses, beginning by categorizing filtered prompt-response pairs into quality tiers based on weighted scores across evaluation criteria. Using configurable thresholds, responses are classified as inferior, mediocre, or superior.

FIG. 29 illustrates an example Algorithm 2900 for Response sampling for users' validation, according to some embodiments. Algorithm 2900 implements response quality segmentation and sampling, which categorizes, and samples prompt-response pairs based on their quality scores. Algorithm 2900 divides responses into three quality tiers (e.g. inferior, mediocre, and superior) by calculating weighted scores from evaluation criteria and comparing them against quality thresholds. After categorizing the responses, Algorithm 2900 strategically samples from each quality tier according to predefined sample sizes, ensuring representative coverage across the quality spectrum while focusing validation efforts on the most informative examples. This final sampling step creates a balanced set of prompt-response pairs for user validation that maximizes learning while minimizing required human effort.

Process 2400 can then draw stratified samples from each quality tier according to predefined sample sizes. This ensures representation across the quality spectrum while prioritizing the validation of responses that will provide the most valuable feedback for system improvement.

The final output can be a strategically selected set of prompt-response pairs organized by quality tier, ready for user validation. This approach ensures that validation efforts focus on responses that:
Represent the full range of system performance;
Include challenging cases that will drive system improvement; and
Provide a balanced view of response quality across different types of prompts.

By strategically sampling across quality segments, the system maximizes the value of user validation while minimizing the required effort, maintaining both efficiency and effectiveness in the response generation process.

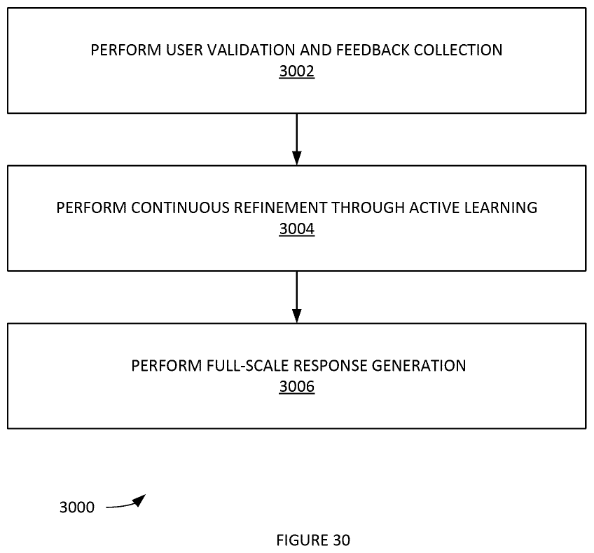

FIG. 30 illustrates an example process 3000 for an ensemble active learning workflow, according to some embodiments. In step 3002 can perform user validation and feedback collection. Process 3000 begins with user validation of sampled prompt-response pairs. In this stage, users review responses and provide feedback to indicate whether they meet expectations. Users have multiple feedback options including editing, regenerating, or refining the responses. To support informed decision-making, the system makes source documents and their metadata available for review. This transparency enhances trust in the generated content and allows users to understand the context behind each response. Process 3000 offers flexibility by allowing feedback either for individual responses or collectively for an entire batch, accommodating different validation workflows and preferences.

In step 3004 process 3000 performs continuous refinement through active learning. Process 3000 applies active learning principles to continuously refine the language model parameters based on collected user feedback. Process 3000 prioritizes prompt-response pairs identified as diverse or infrequent, often using LLM judge scores as a determining factor. This stage implements an ensemble of active learning approaches that work together to improve response quality. These approaches include improvement of instructions to better guide the model, “few-shot examples” to demonstrate desired outputs, and/or improvement of thresholds and weights of filtering and sampling mechanisms to optimize the selection process. This ensemble approach generates better responses and significantly expedites the validation process by focusing refinement efforts where they deliver the most impact.

In step 3006 process 3000 can perform full-scale response generation. Once the refined prompt-response pairs consistently meet user expectations, the process scales to full production. Users can initiate full-scale generation of responses based on the optimized configurations developed through the active learning process. Process 3000 applies these configurations to generate responses for every data chunk across the entire dataset, ensuring comprehensive coverage. This final stage delivers contextually accurate responses that align with user requirements, having been refined through multiple iterations of feedback and improvement. The result is a complete set of high-quality responses suitable for the intended application, whether that is training datasets, knowledge bases, or customer-facing content.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. (canceled)

2. (canceled)

3. The method of claim 21, wherein the ensemble active learning further comprises:
identifying uncertain data points located near decision boundaries;
obtaining user feedback on the uncertain data points;
applying a plurality of learning approaches together to continuously improve data selection; and
updating model parameters based on the user feedback.

4. The method of claim 3, wherein the masterlist comprises:
a hierarchical tree-like data structure wherein each node represents a label and an associated dictionary of keywords;
leaf nodes designated as model nodes for annotation and classification; and
non-leaf nodes designated as non-model nodes that are not used for annotation and classification.

5. The method of claim 4, further comprising:
selecting data points for user validation by segmenting the data points into quality tiers comprising inferior, mediocre, and superior tiers; and
drawing samples from each quality tier according to predefined sample sizes to ensure representation across the quality spectrum.

6. The method of claim 5, wherein the method proceeds in a plurality of stages comprising:
a first stage that utilizes the masterlist to perform a first round of auto-annotation over a subset of the dataset;
a second stage that utilizes both the masterlist and user feedback from the first stage to perform auto-annotation on newer subsets of data across multiple batches; and
a third stage that expands the annotation and classification to an entire dataset.

7. The method of claim 6, wherein the method is applied in a prompt generation workflow comprising:
sampling chunks from which prompts are to be generated;
sampling prompts which are to be validated by users;
generating prompts based on prompt instruction using a large language model; and
evaluating the quality of the prompts based on relevance, simplicity, depth, originality, and completeness.

8. The method of claim 7, wherein the method is applied in a response generation workflow comprising:
retrieving relevant context chunks from a vector database for each prompt;
generating responses using the retrieved context and a large language model;
evaluating responses using an LLM judge across relevance, depth, and correctness dimensions; and
filtering out responses that are similar to previously disliked responses.

9. The method of claim 8, wherein reducing human annotation effort comprises:
calculating a similarity score between a paragraph vector and a node vector;
identifying support vectors and boundary-support vectors to define cluster boundaries;
applying semi-supervised clustering and supervised classification methods in iterative batches; and
automating annotation for data points with high confidence scores.

10. The method of claim 9, further comprising:
training a plurality of machine learning classification models over all validated data;
selecting a best performing model through testing accuracies;
applying hyperparameter tuning to the best performing model using stratified K-fold cross-validation; and
extending annotation to unvalidated data points using the optimized model.

11. (canceled)

12. The method of claim 22, wherein capturing the user's perception comprises:
constructing a Masterlist as a graphical data structure to capture taxonomic relationships of labels and classes with their associated keywords; and
measuring similarity between Masterlist node definitions using vector representations.

13. The method of claim 12, wherein auto-classifying the plurality of text paragraphs comprises:
calculating a similarity score quantifying the association between each text paragraph and each Masterlist node;
ranking the similarity scores to determine the most likely classification; and
assigning each text paragraph to a corresponding Masterlist node based on the highest similarity score.

14. The method of claim 13, wherein generalizing the user validation comprises:
implementing an ensemble of semi-supervised and supervised machine learning algorithms to classify all text paragraphs into Masterlist nodes; and
extending data annotation to all unvalidated text paragraphs through model predictions.

15. The method of claim 14, wherein generating the diverse set of prompts comprises:
implementing divisive sampling to select key data points for user validation;
clustering text chunks based on semantic similarity using K-means;
sampling text chunks from different clusters to maintain diversity; and
filtering prompts based on quality scores to optimize user validation effort.

16. The method of claim 15, wherein producing the quality responses comprises:
clustering prompts based on semantic similarity;
sampling prompts from different clusters to maintain diversity;
retrieving relevant context from a vector database for each prompt;
generating responses using a large language model with appropriate configuration parameters; and
evaluating response quality using predefined criteria.

17. The method of claim 16, wherein improving the auto-annotation comprises:
implementing ensemble active learning to expedite convergence toward higher accuracy;
prioritizing boundary-critical examples near decision boundaries;
continuously refining the models through iterative feedback cycles; and
combining multiple learning approaches to optimize data selection and model performance.

18. The method of claim 17, wherein the method operates in three stages comprising:
a first stage of initial annotation utilizing the Masterlist to perform auto-annotation over a subset of the dataset with mandatory user validation;
a second stage of semi-automated annotation utilizing both the Masterlist and user feedback from the first stage to perform auto-annotation on newer subsets of data across multiple batches; and
a third stage of full annotation utilizing trained models to extend annotation to all unvalidated data.

19. The method of claim 18, wherein identifying data points requiring user validation comprises:
evaluating prompt quality based on relevance, simplicity, depth, originality, and completeness;
evaluating response quality based on relevance, depth, and correctness;
segmenting prompts and responses into quality tiers comprising inferior, mediocre, and superior; and
strategically sampling from each quality tier according to predefined sample sizes.

20. The method of claim 19, wherein the method implements a batch-wise process that combines divisive sampling and ensemble active learning to create system-assisted user workflows for:
classical natural language processing tasks comprising multiclass classification, multilabel classification, and named entity recognition;
prompt generation for large language model fine-tuning; and
response generation for retrieval-augmented generation systems.

21. A computer-implemented method for automated data curation, the method comprising:
receiving a plurality of text paragraphs and a MasterList comprising a plurality of hierarchically related nodes, each node representing a label and having an associated dictionary of keywords;
performing a first annotation stage comprising:
converting each text paragraph of the plurality of text paragraphs into a respective paragraph vector;
generating, for each node of the plurality of hierarchically related nodes, a respective node vector from the dictionary of keywords associated with the node;
for each text paragraph of the plurality of text paragraphs, calculating respective similarity scores between the paragraph vector representing the text paragraph and the node vectors representing the plurality of hierarchically related nodes;
associating the text paragraph with a particular node having a maximum similarity score for the text paragraph;
calculating, from the respective similarity scores, a confidence score estimating a strength of uniqueness of an association between the text paragraph and the particular node, wherein a higher confidence score corresponds to the text paragraph having a high similarity score with only the particular node, and a lower confidence score corresponds to the text paragraph having high similarity scores with multiple nodes of the plurality of hierarchically related nodes;
using the confidence score to identify, among the plurality of text paragraphs, probable support vectors, probable boundary-support vectors, and text paragraphs having high-confidence associations with respective nodes of the plurality of hierarchically related nodes;
strategically selecting, for user validation, text paragraphs from among the probable support vectors, the probable boundary-support vectors, and the text paragraphs having high-confidence associations with the respective nodes; and
receiving user validation of the strategically selected text paragraphs; and
performing a second annotation stage in a plurality of batches, each batch comprising:
identifying, from the plurality of text paragraphs, a plurality of unvalidated text paragraphs;
generating, for each node of the plurality of hierarchically related nodes, a node vector using text paragraphs validated as associated with the node during the first annotation stage or a preceding batch of the second annotation stage;
using the node vectors as initial cluster centers for clustering vectors representing the plurality of unvalidated text paragraphs;
updating the node vectors as the cluster centers during iterations of the clustering;
assigning each unvalidated text paragraph of the plurality of unvalidated text paragraphs to a nearest updated node vector corresponding to one of the plurality of hierarchically related nodes; and
presenting, for user validation, a subset of the assigned text paragraphs and the corresponding nodes.

22. A computer-implemented method for automated data curation with reduced human annotation, the method comprising:
receiving, via a processor, text data comprising a plurality of text paragraphs;
capturing, via the processor, a user's perception of underlying topics, labels, and classes in a hierarchical data structure comprising a MasterList having a plurality of hierarchically related nodes, each node representing a label and having an associated dictionary of keywords;
auto-classifying, via the processor, the plurality of text paragraphs to corresponding classes using similarity scoring, the auto-classifying comprising:
converting each text paragraph of the plurality of text paragraphs into a respective paragraph vector;
generating, for each node of the plurality of hierarchically related nodes, a respective node vector from the dictionary of keywords associated with the node;
for each text paragraph of the plurality of text paragraphs, calculating respective similarity scores between the paragraph vector representing the text paragraph and the node vectors representing the plurality of hierarchically related nodes;
associating the text paragraph with a particular node having a maximum similarity score for the text paragraph;
calculating, from the respective similarity scores, a confidence score estimating a strength of uniqueness of an association between the text paragraph and the particular node, wherein a higher confidence score corresponds to the text paragraph having a high similarity score with only the particular node, and a lower confidence score corresponds to the text paragraph having high similarity scores with multiple nodes of the plurality of hierarchically related nodes;
using the confidence score to identify, among the plurality of text paragraphs, probable support vectors, probable boundary-support vectors, and text paragraphs having high-confidence associations with respective nodes of the plurality of hierarchically related nodes; and
strategically selecting, for user validation, text paragraphs from among the probable support vectors, the probable boundary-support vectors, and the text paragraphs having high-confidence associations with the respective nodes;
generating, via the processor, a diverse set of prompts to ensure comprehensive data coverage using divisive sampling, the generating comprising:
dividing the text data into a plurality of text chunks;
generating a respective embedding for each text chunk of the plurality of text chunks;
clustering the plurality of text chunks, based on the respective embeddings, into a plurality of semantic clusters;
sampling text chunks from different semantic clusters of the plurality of semantic clusters;
combining text chunks sampled from multiple semantic clusters; and
generating, using a large language model, at least one prompt of the diverse set of prompts from the combined text chunks, the at least one prompt spanning multiple topics;
producing, via the processor, quality responses that align with user requirements using an information retrieval system and one or more large language models;
identifying, via the processor, data points requiring user validation using quality evaluation metrics, wherein the data points comprise one or more of the plurality of text paragraphs, the diverse set of prompts, or the quality responses;
improving, via the processor, auto-annotation of new data based on user feedback using ensemble active learning, wherein the new data comprises unvalidated text paragraphs of the plurality of text paragraphs; and
generalizing, via the processor, user validation performed on a sample to a wider set of text for task-specific data curation.

23. A computer-implemented method for automated data curation with reduced human annotation, the method comprising:
receiving, by a processor, text data and user-specified prompt instructions;
dividing, by the processor, the text data into a plurality of text chunks;
generating, by the processor, a respective embedding for each text chunk of the plurality of text chunks;
clustering, by the processor, the plurality of text chunks, based on the respective embeddings, into a plurality of semantically similar clusters;
performing, by the processor, divisive sampling to select text chunks from different clusters of the plurality of semantically similar clusters;
generating, by a large language model, in successive batches and based on the user-specified prompt instructions and text chunks selected from multiple clusters, a plurality of prompts that span multiple topics;
assigning, by the processor, to each prompt of the plurality of prompts, a quality-score vector comprising respective scores for relevance, simplicity, depth, originality, and completeness;
for a first batch of the successive batches:
grouping the prompts generated in the first batch into groups based on respective thresholds for the scores for relevance, simplicity, depth, originality, and completeness;
sampling prompts from the groups for user validation; and
receiving user feedback comprising a like, a dislike, or an edit for each sampled prompt;
for each subsequent batch of the successive batches:
identifying user-disliked prompts from a preceding batch;
calculating a Euclidean distance between the quality-score vector of each prompt generated in the subsequent batch and the quality-score vector of each user-disliked prompt from the preceding batch;
filtering each prompt generated in the subsequent batch when the Euclidean distance between the quality-score vector of the prompt and the quality-score vector of at least one user-disliked prompt is within a predefined threshold;
grouping prompts remaining after the filtering into groups based on the respective thresholds for the scores for relevance, simplicity, depth, originality, and completeness;
sampling prompts from the groups for user validation; and
receiving user feedback comprising a like, a dislike, or an edit for each sampled prompt;
applying ensemble active learning between the successive batches to modify, based on the user feedback, at least one of the user-specified prompt instructions, few-shot examples, the predefined threshold, the respective thresholds, or one or more weights used by filtering and sampling mechanisms; and
in response to determining, based on the user feedback received over the successive batches, that prompt quality meets user requirements, applying an optimized configuration resulting from the ensemble active learning to generate prompts for all text chunks of the text data.
